(19) United States
(12) Patent Application Publication
(10) Pub. No.: US 2023/0069916 A1
(43) Pub. Date: Mar. 9, 2023

(54) GOLFER-ORIENTED INFORMATION PROVIDING METHOD, STORAGE MEDIUM STORING PROGRAM FOR PROVIDING INFORMATION TO GOLFER, AND GOLFER-ORIENTED INFORMATION PROVIDING DEVICE

(71) Applicant: Sumitomo Rubber Industries, Ltd., Kobe-shi (JP)

(72) Inventors: Kazuya KAMINO, Kobe-shi (JP); Atsushi HIRANO, Kobe-shi (JP)

(73) Assignee: Sumitomo Rubber Industries, Ltd., Kobe-shi (JP)

(21) Appl. No.: 17/876,569

(22) Filed: Jul. 29, 2022

(30) Foreign Application Priority Data
Aug. 5, 2021 (JP) 2021-129264

(51) Int. Cl. A63B 71/06; A63B 24/00

(52) U.S. Cl. CPC A63B 71/0622; A63B 24/0006; A63B 2102/32; A63B 2220/05; A63B 2220/807; A63B 2220/808

(57) ABSTRACT

A golfer-oriented information providing method includes steps of inputting needs information regarding a golf swing to a computer, inputting swing attention points and advice information with an information provision priority, inputting reference golf swing information, importing first needs information of a first golfer, inputting first golf swing information of the first golfer, retrieving first reference golf swing information based on the first needs information by the computer, extracting a difference between the first reference golf swing information and the first golf swing information regarding the swing attention points of the first needs information, and selecting the advice information based on a magnitude of the difference and the information provision priority and providing the selected advice information to the first golfer.

### CROSS-REFERENCE TO RELATED APPLICATION

This application claims priority on and the benefit of Patent Application No. 2021-129264 filed in JAPAN on Aug. 05, 2021. The entire disclosures of this Japanese Patent Application are hereby incorporated by reference.

### FIELD

The present disclosure relates to golfer-oriented information providing methods and so forth.

### BACKGROUND

Japanese Patent No. 6544551 describes a swing determination device. This device has an input means for receiving input of a moving image of a swing by a user, a generation means for generating a user image as a still image from the moving image, a plurality of determination means for determining whether the swing is good or bad by comparing the user image with a teacher image, and an output means for outputting the determination result.

### Prior Art

### Patent Document

### Patent Document 1

Japanese Patent No. 6544551

### SUMMARY

Meanwhile, every golfer normally has a specific need regarding a golf swing. Therefore, in order to realize a golf swing matching this need, it is important to provide appropriate advice information in accordance with the need of each golfer, a swing of each individual golfer, and so forth.

The present disclosure was made in view of the above, and a primary object thereof is to provide a golfer-oriented information providing method capable of providing appropriate advice information in accordance with the need and swing of each golfer.

The present disclosure is a golfer-oriented information providing method for providing information to a golfer, including steps of:
inputting pieces of needs information of multiple types regarding a need of a golfer associated with a golf swing to a computer;
inputting, to the computer, for each of the pieces of the needs information of the multiple types, swing attention points for achieving the golf swing satisfying the need and advice information for each of the swing attention points, the advice information being assigned with an information provision priority in regard to each of the pieces of the needs information of the multiple types;
inputting a plurality of pieces of reference golf swing information to the computer, the reference golf swing information being information about a golf swing serving as a target for comparison;
importing first needs information from among the pieces of the needs information of the multiple types into the computer, the first needs information being the needs information requested by a first golfer as a target for providing the information;
inputting first golf swing information to the computer, the first golf swing information being image data of a golf swing of the first golfer;
retrieving first reference golf swing information by the computer based on the first needs information, the first reference golf swing information being one of the pieces of the reference golf swing information most relevant to the first needs information;
extracting, by the computer, a difference in golf swings between the first reference golf swing information and the first golf swing information regarding the swing attention points satisfying the first needs information; and
selecting, by the computer, the advice information based on a magnitude of the difference and the information provision priority and providing the selected advice information to the first golfer.

According to the golfer-oriented information providing method of the present disclosure, it is possible to provide golfers with appropriate advice information in accordance with the need and a swing of each individual golfer.

### BRIEF DESCRIPTION OF THE DRAWINGS

FIG. 1 is a configuration diagram depicting a golfer-oriented information providing system of the present embodiment;

FIG. 2 is a block diagram depicting a portable terminal of the present embodiment;

FIG. 3 is a block diagram depicting a computer of the present embodiment;

FIG. 4 is a diagram depicting the structure of a unique information table of the present embodiment;

FIG. 5 is a diagram depicting the structure of an advice information table of the present embodiment;

FIG. 6 is a diagram depicting the structure of a first golf swing table of the present embodiment;

FIG. 7 is a diagram depicting the structure of a reference golf swing table of the present embodiment;

FIG. 8 is a flowchart depicting a procedure of a golfer-oriented information providing method for the first golfer of the present embodiment;

FIG. 9 is a diagram depicting a unique information input screen of the present embodiment;

FIG. 10 is a diagram depicting a first golf swing information input screen of the present embodiment;

FIG. 11 is a diagram depicting a golf swing subjected to image analysis;

FIG. 12 is a diagram describing a difference in golf swings regarding a swing attention point "way of holding grip at address";

FIG. 13 is a diagram describing a difference in golf swings regarding a swing attention point "timing when the wrist cock is released at downswing";

FIG. 14 is a diagram describing a difference in golf swings regarding a swing attention point "pause duration at swing top";

FIG. 15 is a diagram describing a difference in golf swings regarding a swing attention point "amount of movement of left knee at downswing";

FIG. 16 is a diagram describing a difference in golf swings regarding a swing attention point "swing path";

FIG. 17 is a diagram describing a difference in golf swings regarding a swing attention point "position of golfer's head at address";

FIG. 18 is a diagram describing a difference in golf swings regarding a swing attention point "amount of opening of left underarm at impact";

FIG. 19 is a diagram depicting the structure of an advice information table of another embodiment of the present invention;

FIG. 20 is a diagram describing a difference in golf swings regarding a swing attention point "angle of swing plane"; and

FIG. 21 is a diagram describing a difference in golf swings regarding a swing attention point "swing tempo" and "amount of vertical movement of a golfer's head during swing".

### DETAILED DESCRIPTION

Embodiments of the present disclosure will now be described in conjunction with accompanying drawings. It should be understood that in order to give better understanding of the disclosure, the drawings include exaggerated representations and representations at a scale ratio different from that of the actual structure. Further, the same reference signs are assigned to the same or common components throughout the embodiments, and redundant descriptions thereof are omitted. Furthermore, specific structures described in the embodiments and shown in the drawings are merely for understanding the present disclosure, and the present disclosure is not limited to the specific structures shown in the drawings.

In a golfer-oriented information providing method (hereinafter may simply be referred to as "information providing method") of the present embodiment, to a first golfer as an information provision target, advice information regarding a golf swing suitable for the first golfer is provided. It should be noted that other information may be provided together with the advice information. Further, while the information is provided to the first golfer during play in a golf course in the present embodiment, the information may be provided to the first golfer located, for example, in a golf driving range, in a golf school, at home, or the like.

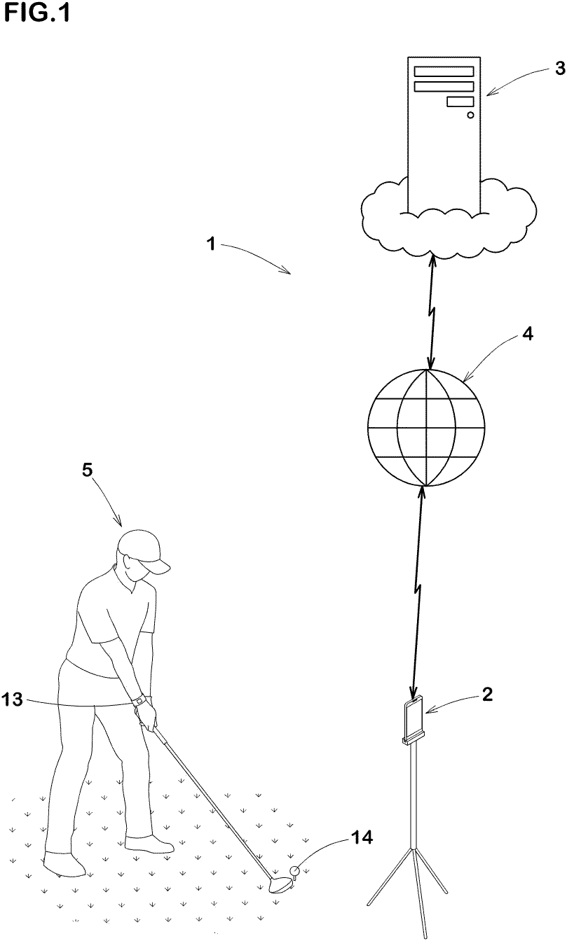

In the information providing method of the present embodiment, a golfer-oriented information providing system (hereinafter, may be simply referred to as "information providing system") is used. FIG. 1 is a structural diagram conceptually depicting a golfer-oriented information providing system 1 of the present embodiment.

### Information Providing System

The information providing system 1 of the present embodiment includes, for example, a portable terminal 2 and a computer 3. The portable terminal 2 and the computer 3 are connected to each other via a communication network 4 such as WAN (Wide Area Network), LAN (Local Area Network), and the like, for example. As the communication network 4 of the present embodiment, WAN (Internet) is adopted. The information providing system 1 may include a plurality of portable terminals (not shown).

### Portable Terminal

The portable terminal 2 of the present embodiment is configured as an electronic device portable by a first golfer 5 (for example, cell-phone, notebook PC, smartphone, tablet-type computer, or the like). As the portable terminal 2 of the present embodiment, a smartphone is adopted. However, this is not particularly restrictive, and any device connectable to the computer 3 via the communication network 4 can be adopted.

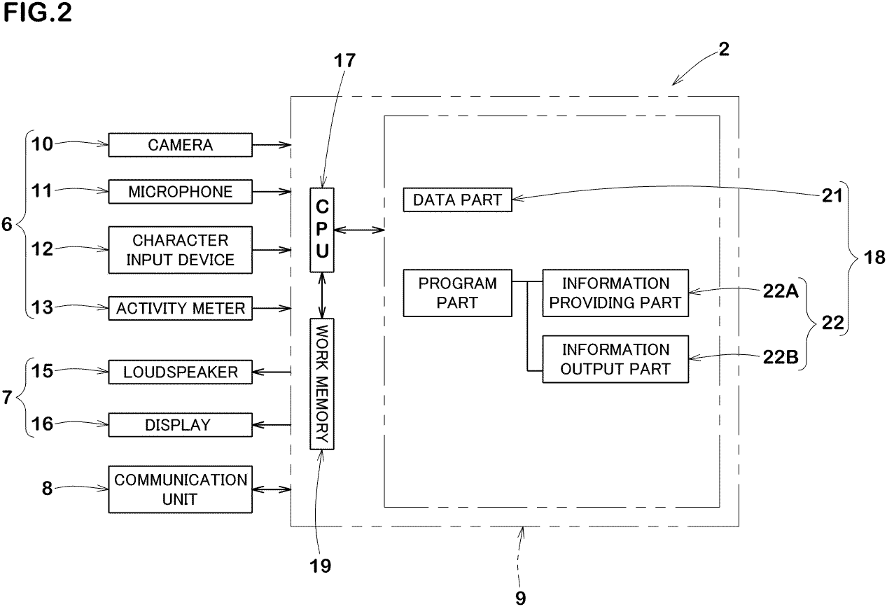

FIG. 2 is a block diagram depicting the portable terminal 2 of the present embodiment. The portable terminal 2 of the present embodiment is configured to include, for example, an input unit 6, an output unit 7, a communication unit 8, and an arithmetic processing device 9.

The input unit 6 of the present embodiment includes, for example, a camera 10, a microphone 11, and a character input device 12 (such as a touch panel or keyboard). The camera 10 is used to input image data of the golf swing of the first golfer 5. The character input device 12 is for inputting character information and so forth. Further, the input unit 6 of the present embodiment may include an activity meter 13 for measuring activity information of the first golfer 5 (for example, heart rate, blood pressure, footstep count, acceleration at the time of a golf swing, and so forth).

The output unit 7 of the present embodiment is for outputting information perceivable by the first golfer 5 (shown in FIG. 1) from the portable terminal 2. The perceivable information includes, for example, voice information, visual information, and so forth.

The output unit 7 of the present embodiment includes, for example, a loudspeaker 15 for outputting voice information and a display 16 for outputting visual information (for example, character information and image information). As the display 16 of the present embodiment, a touch panel display integrally configured with the character input device (touch panel) 12 of the input unit 6 is adopted, but this is not particularly restrictive.

The communication unit 8 of the present embodiment is for transmitting information to the computer 3 and receiving information from the computer 3. The communication unit 8 is connected to the communication network 4 (shown in FIG. 1). As the communication unit 8 of the present embodiment, one compliant with a mobile communication system (for example, a fourth-generation or fifth-generation mobile communication system or the like) is adopted, for example. However, this is not particularly restrictive.

The arithmetic processing device 9 of the present embodiment is configured to include an arithmetic unit (CPU) 17 performing various arithmetic operations, a storage unit 18 for storing data, programs, and so forth, and a work memory 19, for example.

The storage unit 18 of the present embodiment is, for example, a non-volatile and non-transitory tangible information storage medium (device) formed of a flash memory or the like. The storage unit 18 includes a data part 21 and a program part 22.

The data part 21 is for storing information required for execution of the information providing method and information acquired by execution of the information providing method. The data part 21 of the present embodiment is configured of, for example, a database.

The program part 22 is a program (application) required for execution of the information providing method. The program part 22 is executed by the arithmetic unit 17. It is preferred that the program part 22 of the present embodiment is installed on the portable terminal 2 before the information providing method is executed. The program part 22 of the present embodiment is configured to include, for example, an information providing part 22A and an information output part 22B.

The information providing part 22A of the present embodiment has a function of acquiring image data (in the present example, image data of a golf swing by the first golfer 5 (shown in FIG. 1) taken by the input unit 6 (in the present example, the camera 10). Further, the information providing part 22A has a function of providing (transmitting) the image data via the communication unit 8 to the computer 3 shown in FIG. 1. Therefore, by execution of the information providing part 22A, it is possible that the portable terminal 2 of the present embodiment acquires image data (image data of a golf swing by the first golfer 5) and provides that image data to the computer 3.

The information providing part 22A of the present embodiment has a function of acquiring information produced from the first golfer 5 shown in FIG. 1 (voice information, character information, and so forth) from the input unit 6 (the microphone 11, the character input device 12, the activity meter 13, and so forth). Further, the information providing part 22A has a function of providing (transmitting) the acquired information via the communication unit 8 to the computer 3 shown in FIG. 1. Therefore, by execution of the information providing part 22A, it is possible that the portable terminal 2 of the present embodiment acquires information produced from the golfer 5 and provides that information to the computer 3.

The information output part 22B of the present embodiment has a function of acquiring information (in the present example, after-mentioned advice information and the like) outputted from the computer 3 (shown in FIG. 1) via the communication unit 8. Further, the information output part 22B has a function of outputting the acquired information from the output unit 7 (for example, the loudspeaker 15, the display 16, and so forth). Therefore, by execution of the information output part 22B, it is possible that the portable terminal 2 of the present embodiment acquires information outputted from the computer 3 and outputs that information (provides that information to the first golfer 5 shown in FIG. 1).

### Computer

As shown in FIG. 1, the computer 3 of the present embodiment is configured as a server (cloud server), for example.

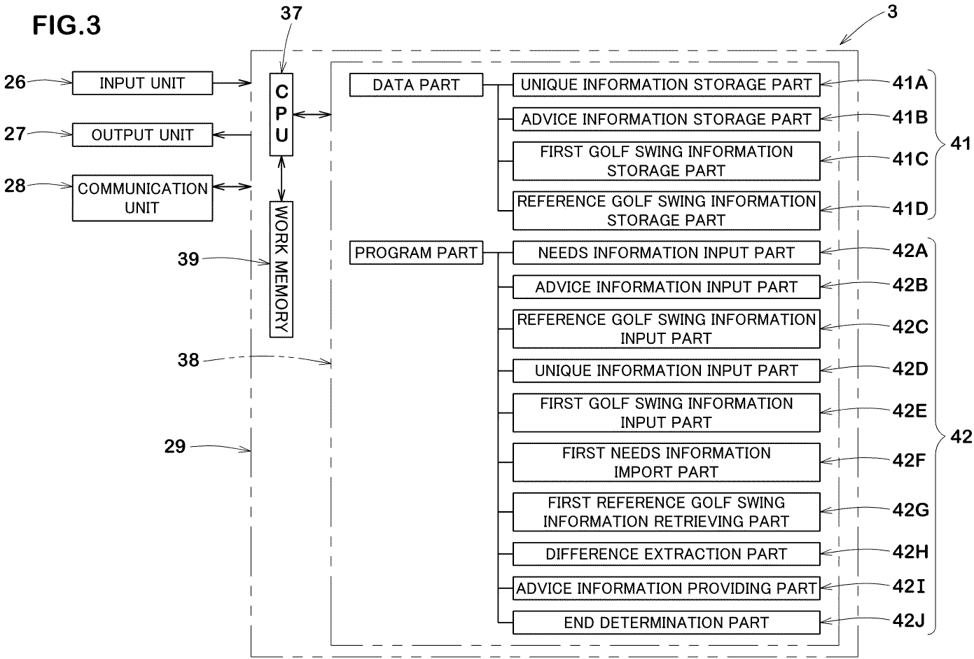

FIG. 3 is a block diagram depicting the computer 3 of the present embodiment. The computer 3 of the present embodiment is configured to include, for example, an input unit 26, an output unit 27, a communication unit 28, and an arithmetic processing device 29.

### Input Unit and Output Unit

As the input unit 26, a keyboard, a mouse, or the like is used, for example. As the output unit 27, a display, a printer, or the like is used, for example.

### Communication Unit

The communication unit 28 of the present embodiment is for receiving information from the portable terminal 2 (shown in FIG. 1) and transmitting information to the portable terminal 2. The communication unit 28 is connected to the communication network 4 (shown in FIG. 1). The communication unit 28 of the present embodiment is configured as, for example, a network adaptor compliant with the Ethernet standards, but this is not particularly restrictive.

### Arithmetic Processing Device

The arithmetic processing device 29 of the present embodiment is configured to include, for example, an arithmetic unit (CPU, processor) 37 for performing various arithmetic operations, a storage unit 38 for storing data, programs, and so forth, and a work memory 39.

### Storage Unit

The storage unit 38 is, for example, a non-volatile information storage device formed of a magnetic disk, optical disk, SSD, and the like. The storage unit 38 includes a data part 41 and a program part 42.

### Data Part

The data part 41 is for storing information required for execution of the information providing method, calculation results acquired by execution of the information providing method, and so forth. The data part 41 of the present embodiment has a unique information storage part 41A, an advice information storage part 41B, a first golf swing information storage part 41C, and a reference golf swing information storage part 41D. The data part 41 of the present embodiment is configured of a database, for example.

### Unique Information Storage Part

The unique information storage part 41A of the present embodiment is for storing unique information of the first golfer 5 (shown in FIG. 1). In the present embodiment, the unique information is information regarding a unique predisposition each first golfer 5 has. The unique information storage part 41A of the present embodiment includes a unique information table including unique information of a plurality of first golfers 5.

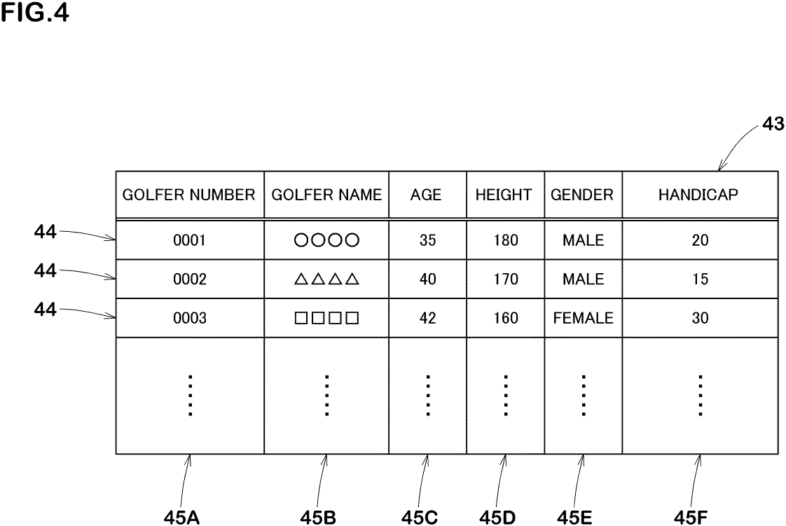

FIG. 4 is a diagram depicting the structure of the unique information table 43 of the present embodiment. In the present embodiment, each record 44 of the unique information table 43 has unique information of a respective one of the first golfers 5 (shown in FIG. 1) stored therein.

In each record 44 of the present embodiment, for example, golfer number 45A, golfer name 45B, age 45C, height 45D, gender 45E, and handicap 45F of the first golfer may be respectively included.

The golfer number 45A is for uniquely identifying the unique information of the first golfer 5 (shown in FIG. 1). As the golfer number 45A of the present embodiment, a number assigned to each first golfer 5 (for example, "0001", "0002", ...) is used. The golfer number 45A is inputted in the item "golfer number" of the unique information table 43.

The golfer name 45B is, for example, the name, nickname, or the like of the first golfer 5 (shown in FIG. 1). The golfer name 45B is inputted as character information in the item "golfer name" of the unique information table 43.

The age 45C, the height 45D, the gender 45E, and the handicap 45F are information about the age, height, gender, and handicap of the first golfer 5. These pieces of information are inputted as character information in items "age", "height", "gender", and "handicap", respectively, of the unique information table 43.

In each item of the unique information table 43, an input of the above-described value may be requisite. Alternatively, for example, in consideration of a case in which the first golfer 5 (shown in FIG. 1) cannot identify unique information (for example, the handicap 45F or the like) or the like, an omission of an input may be permitted. Further, the items of the unique information table 43 are not limited to the above-described items. For example, the above-described items may be partially omitted, or a new item may be added as required.

### Advice Information Storage Part

The advice information storage part 41B (shown in FIG. 3) is for storing advice information to be provided to the first golfer 5 (shown in FIG. 1). The advice information storage part 41B of the present embodiment includes an advice information table containing a plurality of pieces of advice information.

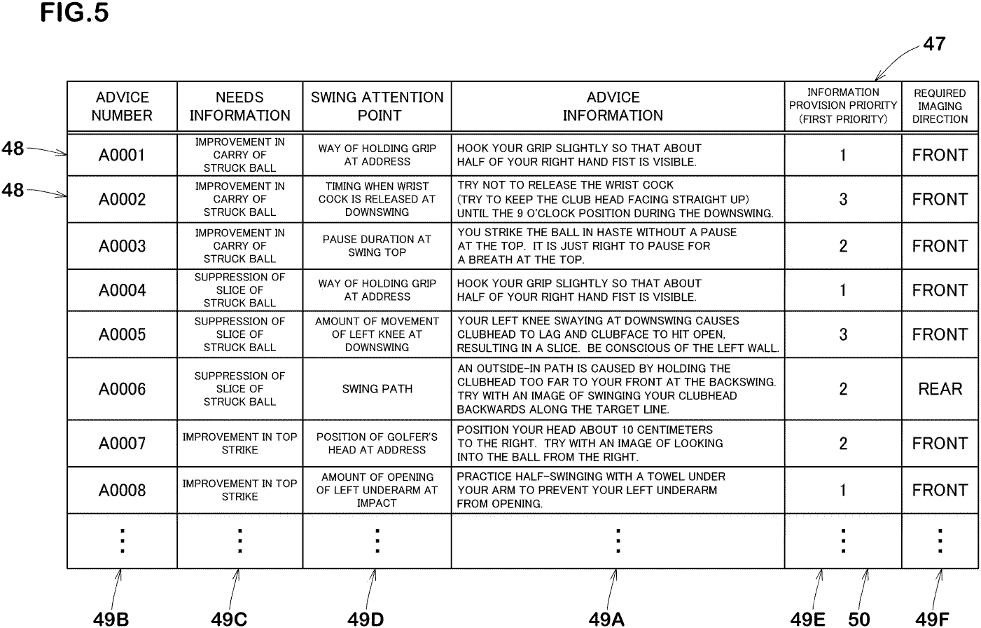

FIG. 5 is a diagram depicting the structure of an advice information table 47 of the present embodiment. In the present embodiment, one piece of advice information 49A is inputted in each record 48 of the advice information table 47. In the present embodiment, a plurality of pieces of advice information 49A (records 48) are inputted at Step S2 as stated below.

The records 48 of the present embodiment each include, for example, advice number 49B, needs information 49C, swing attention point 49D, advice information 49A, information provision priority 49E, and required imaging direction 49F.

The advice number 49B is for uniquely identifying the advice information 49A. In the present embodiment, a different advice number 49B (for example, "A0001", "A0002", ...) is assigned for each piece of advice information 49A. The advice number 49B is inputted in the item "advice number" of the advice information table 47.

The needs information is information regarding a need (goal) corresponding to the advice information 49A. In the present embodiment, one piece of needs information 49C is inputted as character information in the item "needs information" of each record 48.

The swing attention point 49D is a technical point that is important in achieving a golf swing matching the above-described need (goal). In the present embodiment, a plurality of swing attention points 49D are inputted for each of the pieces of needs information 49C of multiple types at Step S2 as stated below. Details of the swing attention points 49D will be described in the description of Step S2 later. In the present embodiment, one swing attention point 49D is inputted as character information in the item "swing attention point" of each record 48.

The advice information 49A is information regarding an advice for the first golfer 5 on a golf swing. In the present embodiment, at Step S2 as stated below, for each of the swing attention points 49D, at least one piece of the advice information 49A which is helpful in improving that swing attention point 49D is inputted. In the present embodiment, one piece of the advice information 49A is inputted as character information in the item "advice information" of each record 48.

The information provision priority 49E indicates an order for selecting at least one piece of the advice information 49A from the pieces of the advice information 49A for each of the pieces of the needs information 49C of the multiple types. The information provision priority 49E of the present embodiment includes a first priority 50. In the present embodiment, one information provision priority 49E (first priority 50) is inputted as character information (number) in the item "information provision priority 49E (first priority 50)" of each record 48.

The required imaging direction 49F is for identifying the golf swing imaging direction required to identify each of the multiple swing attention points 49D. In the present embodiment, at Step S2 as stated below, at least one imaging direction 49F is inputted for each of the swing attention points 49D. While the required imaging direction 49F of the present embodiment is selected from "front" and "rear" of the first golfer 5, the directions may include "back", "directly above", and so forth of the first golfer 5. In the present embodiment, one imaging direction 49F is inputted as character information in the item "required imaging direction" of each record 48.

The items of the advice information table 47 are not limited to the above-described items. For example, the above-described items may be partially omitted, or new items may be added as required.

### First Golf Swing Information Storage Part

The first golf swing information storage part 41C (shown in FIG. 3) is for storing first golf swing information, which is image data of a golf swing of the first golfer 5 (shown in FIG. 1). The first golf swing information storage part 41C of the present embodiment includes a first golf swing table containing a plurality of pieces of first golf swing information.

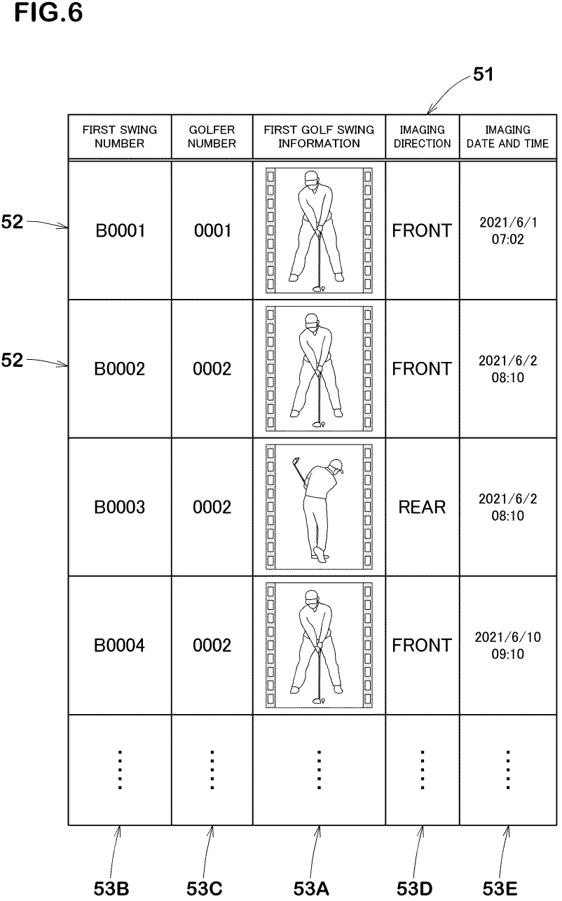

FIG. 6 is a diagram depicting the structure of a first golf swing table 51 of the present embodiment. In the present embodiment, one piece of first golf swing information 53A is inputted in each record 52 of the first golf swing table 51.

In each record 52 of the present embodiment, first swing number 53B, golfer number 53C, first golf swing information 53A, imaging direction 53D, and imaging date and time 53E are included, for example.

The first swing number 53B is for uniquely identifying the first golf swing information 53A. In the present embodiment, a different first swing number 53B (for example, "B0001", "B0002", ...) is assigned for each piece of the first golf swing information 53A. The first swing number 53B is inputted in the item "first swing number" of the first golf swing table 51.

The golfer number 53C is for identifying the first golfer 5 whose golf swing is shot as the first golf swing information 53A. This golfer number 53C is inputted in accordance with the golfer number 45A stored in the unique information table 43 shown in FIG. 4. The golfer number 53C is inputted in the item "golfer number" of the first golf swing table 51.

The first golf swing information 53A is image data of the golf swing of the first golfer 5. An example of the image data of the present embodiment is a moving image obtained by continuously taking images of a series of motions from address to finish in a golf swing. Alternatively, a still image obtained by taking part of the series of motions may be used. The first golf swing information 53A is inputted in the item "first golf swing information" of the first golf swing table 51.

The imaging direction 53D is for identifying the imaging direction of the golf swing of the first golfer 5 (shown in FIG. 1). While the imaging direction 53D of the present embodiment is selected from "front" and "rear" of the first golfer 5, the directions may include "back", "directly above", and so forth of the first golfer 5. The imaging direction 53D is inputted in the item "imaging direction" of the first golf swing table 51.

The imaging date and time 53E is for identifying a date and time when the first golf swing information 53A is inputted (that is, when the golf swing of the first golfer 5 (shown in FIG. 1) is shot). The imaging date and time 53E of the present embodiment includes a date and time, for example, but part of these may be omitted. The imaging date and time 53E of the present embodiment is inputted in the item "imaging date and time" of the first golf swing table 51.

The items of the first golf swing table 51 are not limited to the above-described items. The above-described items may be partially omitted, or new items may be added as required, for example.

### Reference Golf Swing Information Storage Part

The reference golf swing information storage part 41D (shown in FIG. 3) is for storing reference golf swing information. The reference golf swing information of the present embodiment is a golf swing serving as a target for comparison, i.e., a good example, in achieving a golf swing matching the need of the first golfer 5 (shown in FIG. 1). The reference golf swing information storage part 41D of the present embodiment includes a reference golf swing table containing a plurality of pieces of reference golf swing information.

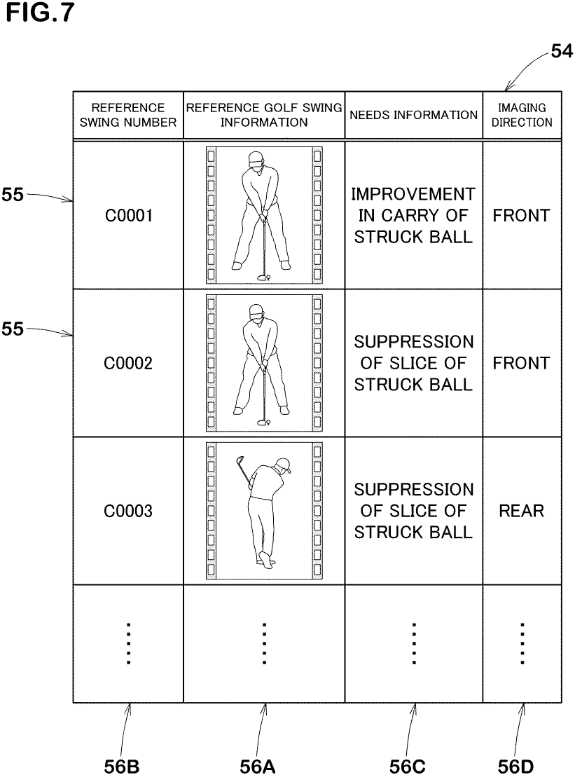

FIG. 7 is a diagram depicting the structure of the reference golf swing table 54 of the present embodiment. In the present embodiment, one piece of the reference golf swing information 56A is inputted in each record 55 of the reference golf swing table 54. In the present embodiment, multiple pieces of the reference golf swing information 56A (records 55) are inputted at Step S3 described later.

Each record 55 of the reference swing number 56B in the present embodiment includes reference golf swing information 56A, needs information 56C, and imaging direction 56D, for example.

The reference swing number 56B is for uniquely identifying the reference golf swing information 56A. In the present embodiment, each piece of reference golf swing information 56A is assigned with a different reference swing number 56B (for example, "C0001", "C0002", ...). The reference swing number 56B is inputted in the item "reference swing number" of the reference golf swing table 54.

The reference golf swing information 56A indicates image data of a golf swing serving as a target for comparison, i.e., a good example, in achieving a golf swing matching the need of the first golfer 5 (shown in FIG. 1). As with the first golf swing information 53A of the first golf swing table 51 shown in FIG. 6, the image data may be a moving image or a still image in the present embodiment. The reference golf swing information 56A is inputted in the item "reference golf swing information" of the reference golf swing table 54.

The needs information 56C is for identifying a golf swing (reference golf swing information 56A) serving as a target for comparison, i.e., a good example, in satisfying the needs of the first golfer 5 from among plural pieces of the reference golf swing information 56A. The needs information 56C of the present embodiment is selected from pieces of needs information of multiple types, which will be described later below. The needs information 56C is inputted as character information in the item "needs information" of the reference golf swing table 54.

The imaging direction 56D is for identifying an imaging direction in which the image of the reference golf swing information 56A is taken. The imaging direction 56D of the present embodiment can be selected in a manner similar to that of the imaging direction 53D of the first golf swing table 51 shown in FIG. 6. The imaging direction 56D is inputted as character information in the item "imaging direction" of the reference golf swing table 54.

The items of the reference golf swing table 54 are not limited to the above-described items. Part of the above-described items may be omitted, or new items may be added as required, for example.

### Program Part

As shown in FIG. 3, the program part 42 is programs required for execution of the information providing method. The program part 42 is executed by the arithmetic unit 37. The program part 42 of the present embodiment includes, for example, a needs information input part 42A, an advice information input part 42B, and a reference golf swing information input part 42C. Further, the program part 42 includes a unique information input part 42D, a first golf swing information input part 42E, a first needs information import part 42F, a first reference golf swing information retrieving part 42G, a difference extraction part 42H, advice information providing part 42I, and an end determination part 42J. These functions of the program part 42 are described in the description of each step of the information providing method described below.

### Golfer-Oriented Information Providing Method (First Embodiment)

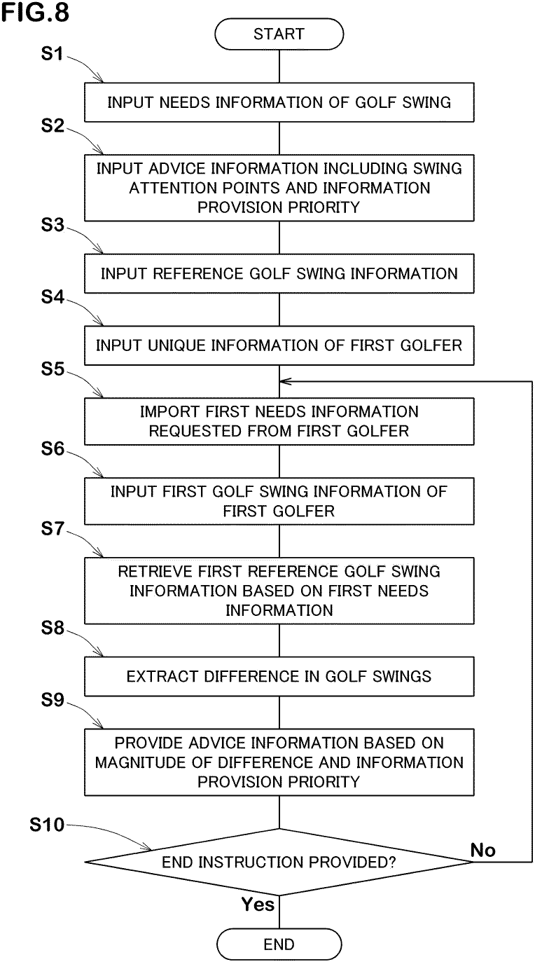

Next, the procedure of the information providing method of the present embodiment is described. FIG. 8 is a flowchart depicting a procedure of the information providing method for the first golfer 5 in the present embodiment.

### Input of Needs Information of Golf Swing

In the information providing method of the present embodiment, firstly, pieces of needs information of multiple types regarding needs of the golfer associated with the golf swing are inputted to the computer 3 (shown in FIG. 1 and FIG. 3) (Step S1). In the present embodiment, the needs information input part 42A of the computer 3 shown in FIG. 3 is read into the work memory 39. Then, with the needs information input part 42A executed by the arithmetic unit 37, the computer 3 is caused to function as a unit (means) for receiving input of the pieces of needs information of the multiple types regarding the needs of the golfer associated with the golf swing. At Step S1 in the present embodiment, by an operator operating the computer 3 functioning as the above-described means, the pieces of needs information 49C of the multiple types (shown in FIG. 5) are inputted to the advice information table 47 (database) shown in FIG. 5, for example.

Generally speaking, each golfer (including the first golfer 5 shown in FIG. 5) has a specific need (goal) associated with the golf swing. As shown in FIG. 5, the needs information 49C includes, for example, "improvement in carry of struck ball", "suppression of slice of struck ball", "improvement in top strike (that is, strike on an upper portion of a ball 14)". While all of these pieces of needs information are included in the needs information in the present embodiment, part of these may be omitted, or a new piece of needs information may be added as required.

At Step S1 of the present embodiment, any one of the above-described pieces of the needs information 49C is inputted in the item "needs information" of each record 48 of the advice information table 47 (shown in FIG. 5) stored in the advice information storage part 41B of the computer 3 shown in FIG. 3.

### Input of Swing Attention Points and Advice Information

Next, in the information providing method of the present embodiment, the swing attention points 49D and pieces of the advice information 49A are inputted to the computer 3 (shown in FIG. 1 and FIG. 3) for each of the pieces of the needs information 49C of the multiple types shown in FIG. 5 (Step S2). In the present embodiment, the advice information input part 42B of the computer 3 shown in FIG. 3 is read into the work memory 39. Then, by the arithmetic unit 37 executing the advice information input part 42B, the computer 3 is caused to function as means for inputting a plurality of the swing attention points 49D and multiple pieces of the advice information 49A. At Step S2 of the present embodiment, by the operator operating the computer 3 functioning as the above-described means, the swing attention points 49D and the pieces of the advice information 49A are inputted to the advice information table 47 (database) shown in FIG. 5.

As shown in FIG. 5, at Step S2 in the present embodiment, the plurality of the swing attention points (important technical points) 49D for achieving a golf swing matching the need (needs information) are inputted for each piece of the needs information 49C of the multiple types. Further, at Step S2, the advice information 49A for each of the swing attention points 49D is inputted.

### Input of Swing Attention Points and Advice Information (Improvement in Carry of Struck Ball)

The needs information 49C of the present embodiment includes "improvement in carry of struck ball". The swing attention points 49D for achieving this need "improvement in carry of struck ball" include, for example, "way of holding grip at address", "timing when wrist cock is released at downswing", and "pause duration at swing top". At Step S2 in the present embodiment, these swing attention points 49D are inputted in the item "swing attention point" of the records 48 containing "improvement in carry of struck ball" as the needs information 49C in the advice information table 47. It should be noted that the swing attention points 49D are not limited to these and only part of these swing attention points 49D may be inputted or other swing attention points (not shown) may be further included.

The swing attention point 49D "way of holding grip at address" includes weak grip, square grip, and strong grip, for example. Of these grips, the weak grip tends to transmit less power to the ball 14 (shown in FIG. 1) than the other grips, making it more difficult to achieve a long carry. Therefore, for the first golfer 5 (shown in FIG. 1) having the need "improvement in carry of struck ball" and having the weak grip, it is effective to provide specific advice such as, for example, "Hook your grip slightly so that about half of your right fist is visible.", as the advice information 49A. In the present embodiment, the above-described advice information 49A is inputted in the item "advice information" of the records 48 having the needs information 49C "improvement in carry of struck ball" and the swing attention point 49D "way of holding grip at address".

The swing attention point 49D "timing when wrist cock is released at downswing" means timing during a down swing when the golfer returns his or her wrists to the original angle at address (i.e., releases wrist cock) from the state in which the wrists are bent toward the thumbs (vertical direction). For example, if the wrist cock is released too early, the head speed cannot be sufficiently increased, making it less likely to achieve a long carry. Therefore, for the first golfer 5 (shown in FIG. 1) having the need "improvement in carry of struck ball" and early timing of releasing the wrist cock, it is effective to provide a specific advice such as, for example, "Try not to release the wrist cock (try to keep the club head facing straight up) until the 9 o'clock position during the downswing." as the advice information 49A. In the present embodiment, the above-described advice information 49A is inputted in the item "advice information" of the records 48 having the needs information 49C "improvement in carry of struck ball" and the swing attention point 49D "timing when wrist cock is released at downswing".

The swing attention point 49D "pause duration at swing top" means a time length of a transition from the swing top to the downswing. If the pause duration at the swing top is short, the golfer strikes the ball in a rush and cannot accumulate enough energy, which tends to make it difficult to achieve a long carry. Therefore, for the first golfer 5 (shown in FIG. 1) having the need "improvement in carry of struck ball" and whose pause duration at the swing top is short, it is effective to provide a specific advice such as, for example, "You strike the ball in a rush without a pause at the top. It is just right to pause for a breath at the top.", as the advice information 49A. At Step S2 in the present embodiment, the above-described advice information 49A is inputted in the item "advice information" of the records 48 having the needs information 49C "improvement in carry of struck ball" and the swing attention point 49D "pause duration at swing top".

Meanwhile, if the first golfer 5 (shown in FIG. 1) has room for improvement in multiple swing attention points 49D and is provided with corresponding pieces of the advice information 49A all at the same time, the first golfer 5 may be confused. Further, in order to achieve a golf swing satisfying (matching) the needs, the above-described swing attention points 49D may have order of priority (degrees of importance) for the improvement.

For example, in order to achieve the need "improvement in carry of struck ball", among the above-described swing attention points 49D, improvement in "way of holding grip at address" is considered to be the most important for the first golfer 5 (shown in FIG. 1). This is because the first golfer 5 with a poor "way of holding grip at address" is less likely to achieve the need "improvement in carry of struck ball" even if the golfer tries hard to improve "timing when wrist cock is released at downswing" and "pause duration at swing top".

Next, for the first golfer 5 (shown in FIG. 1) with a good (improved) "way of holding grip at address", the improvement in "pause duration at swing top" is more important than the improvement in "timing when wrist cock is released at downswing". It is possible that the first golfer 5 with a good "way of holding grip at address" and good "timing when wrist cock is released at downswing" reliably achieves the need "improvement in carry of struck ball" by improving "timing when wrist cock is released at downswing".

As just described, since the above-described swing attention points 49D have order of priority (degrees of importance) of improvement in order to achieve a swing satisfying the needs. Therefore, it is preferred to provide the first golfer 5 with the advice information 49A having a higher degree of importance preferentially.

In the present embodiment, among the above-described swing attention points 49D, the advice information 49A "way of holding grip at address" has the highest degree of importance. Thus, the number "1" is inputted in the item "information provision priority (first priority)" of the records 48 having the advice information 49A"way of holding grip at address". Next, since the advice information 49A "pause duration at swing top" has the second highest degree of importance, the number "2" is inputted in the item "information provision priority (first priority)" of the records 48 having the advice information 49A"pause duration at swing top". Next, since the advice information 49A "timing when wrist cock is released at downswing" has the third highest degree of importance, the number "3" is inputted in the item "information provision priority (first priority)" of the records 48 having the advice information 49A"timing when wrist cock is released at downswing". With the information provision priority 49E (first priority 50) being set in the advice information table 47 as such, it is possible to provide the first golfer 5 (shown in FIG. 1) with the advice information 49A having a high degree of importance at Step S9 as described later.

In order to identify the swing attention points 49D for the needs information 49C "improvement in carry of struck ball" among the swing attention points 49D"way of holding grip at address", "timing when wrist cock is released at downswing", and "pause duration at swing top", it is preferred that the image of the golf swing is taken from the front. Therefore, "front" is inputted in the item "required imaging direction" of the records 48 with the needs information 49C "improvement in carry of struck ball".

### Input of Swing Attention Points and Advice Information (Suppression of Slice of Struck Ball)

The needs information 49C of the present embodiment includes "suppression of slice of struck ball". The swing attention points 49D for achieving this needs information "suppression of slice of struck ball" include, for example, "way of holding grip at address", "amount of movement of left knee at downswing", and "swing path". At Step S2 in the present embodiment, these swing attention points 49D are inputted in the item "swing attention point" of the records 48 having "suppression of slice of struck ball" as the needs information 49C in the advice information table 47. It should be noted that the swing attention points 49D are not limited to the mode described above and only part of these swing attention points 49D may be inputted or other swing attention points (not shown) may be further included.

The swing attention point 49D "way of holding grip at address" includes the above-described grips, for example. Among these grips, the weak grip tends to open the clubface earlier and slice more easily than the other grips. Therefore, for the first golfer 5 (shown in FIG. 1) having the needs information "suppression of slice of struck ball" and having the weak grip, it is effective to provide a specific advice such as, for example, " Hook your grip slightly so that about half of your right fist is visible." as the advice information 49A. At Step S2 in the present embodiment, the above-described advice information 49A is inputted in the item "advice information" of the record 48 with the needs information 49C "suppression of slice of struck ball" and the swing attention point 49D "way of holding grip at address".

The swing attention point 49D "amount of movement of left knee at downswing" is an amount of movement in a lateral direction of the left knee of the first golfer 5 (shown in FIG. 1) from the start of a downswing to an impact. If this amount of movement is large, the clubface tends to open and slice easily. Therefore, for the first golfer 5 having the need information "suppression of slice of struck ball" and having a large amount of movement of the left knee, it is effective to provide a specific advice such as, for example, "Your left knee swaying at the downswing causes the clubhead to lag and the clubhead to hit open, resulting in a slice. Be conscious of the left wall." as the advice information 49A. At Step S2 in the present embodiment, the above-described advice information 49A is inputted in the item "advice information" of the records 48 with the needs information 49C "suppression of slice of struck ball " and the swing attention point 49D "amount of movement of left knee at downswing".

The swing attention point 49D "swing path" includes inside-in, inside-out, and outside-in, for example. Among these paths, the outside-in tends to cause the clubface open at the impact and thereby slice more easily than the other paths. Therefore, for the first golfer 5 (shown in FIG. 1) having the needs information "suppression of slice of struck ball" and having the outside-in swing path, it is effective to provide a specific advice such as, for example, "An outside-in path is caused by holding the clubhead too far to your front at the backswing. Try with an image of swinging your clubhead backwards along the target line.", as the advice information 49A. At Step S2 in the present embodiment, the above-described advice information 49A is inputted in the item "advice information" of the records 48 having the needs information 49C "suppression of slice of struck ball" and the swing attention point 49D "swing path".

In order to achieve a swing satisfying the needs, the above-described swing attention points 49D have order of priority (degrees of importance) as to improvement. For example, in order to achieve the needs information "suppression of slice of struck ball", improvement in "way of holding grip at address" is considered to be the most important for the first golfer 5 (shown in FIG. 1) among the above-described swing attention points 49D. Next, for the first golfer 5 (shown in FIG. 1) with a good (improved) "way of holding grip at address", the improvement in the "swing path" is more important than the improvement in "amount of movement of left knee at downswing". For the first golfer 5 with a good "way of holding grip at address" and good "swing path", it is possible to reliably achieve the needs "suppression of slice of struck ball" by improving the "amount of movement of left knee at downswing".

In the present embodiment, among the above-described swing attention points 49D, the advice information 49A "way of holding grip at address" has the highest degree of importance. Thus, the number "1" is inputted in the item "information provision priority (first priority)" of the records 48 having the advice information 49A "way of holding grip at address". Next, since the advice information 49A "swing path" has the second highest degree of importance, the number "2" is inputted in the item "information provision priority (first priority)" of the records 48 having the advice information 49A "swing path". Next, since the advice information 49A "amount of movement of left knee at downswing" has the third highest degree of importance, the number "3" is inputted in the item "information provision priority (first priority)" of the records 48 having the advice information 49A "amount of movement of left knee at downswing". With the information provision priorities 49E (first priorities 50) being set in the advice information table 47 as such, it is possible at Step S9 described below to provide the advice information 49A based on the information provision priorities 49E.

It is preferred that an image of a golf swing is taken from the front in order to identify the swing attention points 49D "way of holding grip at address" and "amount of movement of left knee at downswing" in the needs information 49C "suppression of slice of struck ball". Thus, "front" is inputted in the item "required imaging direction" of the records 48 having these swing attention points 49D. On the other hand, it is preferred that an image of a golf swing is taken from rear in order to identify the swing attention point 49D "swing path". Therefore, "rear" is inputted in the item "required imaging direction" of the records 48 having this swing attention point 49D "swing path".

### Input of Swing Attention Points and Advice Information (Improvement in Top Strike)

The needs information 49C of the present embodiment includes "improvement in top strike". The swing attention points 49D for achieving this needs "improvement in top strike" include, for example, "position of golfer's head at address" and "amount of opening of left underarm at impact". At Step S2 in the present embodiment, in the advice information table 47, these swing attention points 49D are inputted in the item "swing attention point" of the records 48 having "improvement in top strike" as the needs information 49C. It should be noted that the swing attention points 49D are not limited to the above mode and at least only part of these swing attention points 49D may be inputted or other swing attention points may be further included.

The swing attention point 49D "position of golfer's head at address" is the position of the head of the first golfer 5 with respect to the ball 14 shown in FIG. 1. If the position of the head of the first golfer 5 is shifted too much to the left side (right side when the first golfer 5 is viewed from the front) with respect to the ball 14, the golfer tends to gaze at an upper portion of the ball 14 and to strike the upper portion of the ball 14 (tends to make a top strike). Therefore, for the first golfer 5 having the needs "improvement in top strike" and whose head is positioned to the left at address, it is effective to provide a specific advice such as, for example, "Position your head about 10 cm to the right. Try with an image of looking into the ball from the right.", as the advice information 49A. At Step S2 in the present embodiment, the above-described advice information 49A is inputted in the item "advice information" of the records 48 having the needs information 49C "improvement in top strike" and the swing attention point 49D "position of golfer's head at address".

The swing attention point 49D "amount of opening of left underarm at impact" is an amount of opening in a lateral direction of the left underarm of the first golfer 5 (shown in FIG. 1) at impact. If this amount of opening is large, the golfer tends to hit an upper portion of the ball 14 (tends to make a top strike). Therefore, for the first golfer 5 having the need "improvement in top strike" and whose amount of opening of the left underarm is large, it is effective to provide a specific advice such as, for example, "Practice half-swinging with a towel under your arm to prevent your left underarm from opening.", as the advice information 49A. At Step S2 in the present embodiment, the above-described advice information 49A is inputted in the item "advice information" of the records 48 having the needs information 49C "improvement in top strike" and the swing attention point 49D "amount of opening of left underarm at impact".

In order to achieve a swing satisfying the needs, the above-described swing attention points 49D have priorities (degrees of importance) regarding improvement. For example, in order to achieve the need "improvement in top strike," among the above-described swing attention points 49D, an improvement in "amount of opening of left underarm at impact" is considered to be the most important for the first golfer 5. Next, for the first golfer 5 with a good (improved) "amount of opening of left underarm at impact", it is possible to reliably achieve the need "improvement in top strike" by improving the "position of golfer's head at address".

In the present embodiment, among the above-described swing attention points 49D, the advice information 49A "amount of opening of the left underarm at impact" has the highest degree of importance. Thus, the number "1" is inputted in the item "information provision priority (first priority)" of the records 48 having the advice information 49A "amount of opening of the left underarm at impact". Next, since the advice information 49A "position of golfer's head at address" has the second highest degree of importance, the number "2" is inputted in the item "information provision priority (first priority)" of the records 48 having the advice information 49A"position of golfer's head at address". With the information provision priorities 49E (first priorities 50) configured as such being set in the advice information table 47, it is possible to provide the advice information 49A based on the information provision priorities 49E at Step S9 described further below.

In order to identify the swing attention points 49D "position of golfer's head at address" and "amount of opening of left underarm at impact" in the needs information 49C "improvement in top strike", it is preferred that an image of a golf swing is taken from the front. Therefore, "front" is inputted in the item "required imaging direction" of the records 48 having the needs information 49C "improvement in top strike".

### Input of Reference Golf Swing Information

Next, in the information providing method of the present embodiment, a plurality of pieces of reference golf swing information 56A (shown in FIG. 7) as information about a golf swing serving as a target for comparison are inputted to the computer 3 (shown in FIG. 1 and FIG. 3) (Step S3). At Step S3 in the present embodiment, the reference golf swing information input part 42C of the computer 3 shown in FIG. 3 is read into the work memory 39. Then, with the reference golf swing information input part 42C executed by the arithmetic unit 37, the computer 3 is caused to function as means for inputting the plurality of pieces of the reference golf swing information 56A. At Step S3 in the present embodiment, by the operator operating the computer 3 functioning as the above-described means, the pieces of the reference golf swing information 56 are inputted to the reference golf swing table 54 (database) shown in FIG. 7.

As described above, the reference golf swing information 56A indicates a golf swing serving as a target for comparison (as a good example) in achieving a golf swing satisfying the needs of the first golfer 5 (shown in FIG. 1). At Step S3 in the present embodiment, plural pieces of the reference golf swing information 56A satisfying the needs are inputted for each of the pieces of the needs information 56C of multiple types ("improvement in carry of struck ball" and "suppression of slice of struck ball", for example).

The reference golf swing information 56A is used for comparison with the golf swing (first golf swing information 53A (shown in FIG. 6)) of the first golfer 5 shown in FIG. 1 to extract a difference therebetween at Step S8 described later. Thus, the reference golf swing information 56A may include, for example, a golf swing of a golfer with the same unique predisposition (such as age) as the first golfer 5. The reference golf swing information 56A configured as such can serve as a target for comparison to achieve a golf swing matching the needs of the first golfer 5. Further, it is preferred that the reference golf swing information 56A includes a golf swing of an advanced golfer with higher skill than the first golfer 5 (for example, a coach at golf school).

At Step S3 in the present embodiment, images of pieces of the reference golf swing information 56A taken in advance are inputted to the item "reference golf swing information" of the records 55 of the reference golf swing table 54. Furthermore, the needs information 56C achieved in the reference golf swing information 56A is inputted to the item "needs information", and the imaging direction 56D of the reference golf swing information 56A is inputted to the item "imaging direction". These records 55 are each assigned with the reference swing number 56B.

It should be noted that it is preferred to include the reference golf swing information 56A with the images taken from the rear in order to compare the swing attention point "swing path" for the needs information 56C "suppression of slice of struck ball". Therefore, it is preferred that the records 55 having the needs information 56C "suppression of slice of struck ball" includes the records 55 having the reference golf swing information 56A with an image taken from the front and the records 55 including the reference golf swing information 56A with an image taken from the rear.

### Input of Unique Information

Next, in the information providing method of the present embodiment, the unique information of the first golfer 5 (shown in FIG. 1) is inputted to the computer 3 (shown in FIG. 1 and FIG. 3) (Step S4). In the present embodiment, the first golfer 5 operates the portable terminal 2 to input the unique information of the first golfer 5. Then, the inputted unique information is transmitted to the computer 3 and is inputted to (registered in) the unique information table 43 (database) shown in FIG. 4.

At Step S4 in the present embodiment, firstly, by the first golfer 5 shown in FIG. 1 operating the portable terminal 2, the program part 22 shown in FIG. 2 (the information providing part 22A and the information output part 22B) is read into the work memory 19 to be executed by the arithmetic unit 17. Further, the unique information input part 42D of the computer 3 shown in FIG. 3 is read into the work memory 39. Then, by the arithmetic unit 37 executing the unique information input part 42D, the computer 3 is caused to function as means for inputting the unique information of the first golfer 5.

In the present embodiment, the computer 3 shown in FIG. 1 transfers a signal to the portable terminal 2 via the communication network 4 to cause the portable terminal 2 shown in FIG. 3 to display a unique information input screen on the display 16.

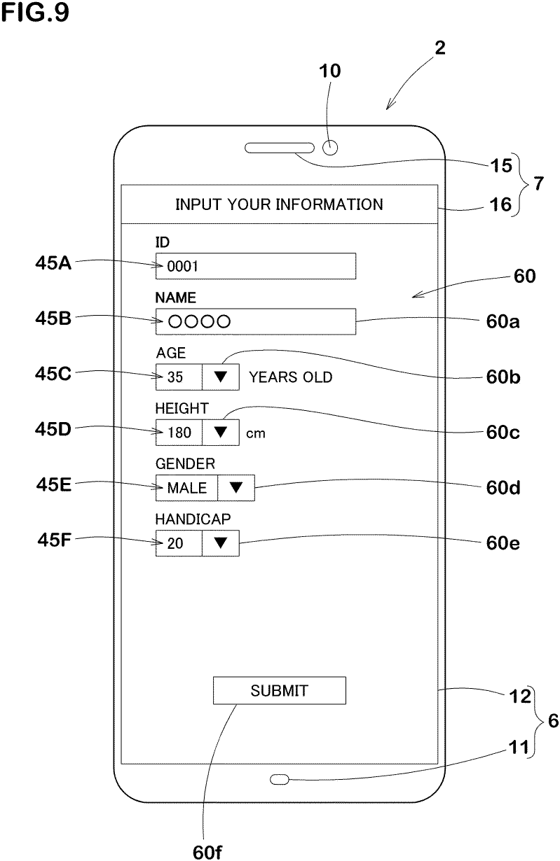

FIG. 9 is a diagram depicting a unique information input screen 60 of the present embodiment. The unique information input screen 60 is for the first golfer 5 (shown in FIG. 1) to input his or her unique information. With the information output part 22B of the portable terminal 2 shown in FIG. 2 executed by the arithmetic unit 17 based on a signal from the computer 3 (shown in FIG. 1), the unique information input screen 60 is displayed on the display 16.

The unique information input screen 60 of the present embodiment includes, for example, a golfer name input part 60a, an age input part 60b, a height input part 60c, a gender input part 60d, and a handicap input part 60e.

The golfer name input part 60a is for inputting the golfer name 45B (name of the first golfer 5). The name, nickname, or the like of the first golfer 5 (shown in FIG. 1) are directly inputted to the golfer name input part 60a by using a language input system (Input Method Editor) of the portable terminal 2, for example. It should be noted that the golfer's name may be inputted by the voice of the first golfer 5 via the microphone 11 of the portable terminal 2, for example.

The age input part 60b is for inputting the age 45C of the first golfer 5. The height input part 60c is for inputting the height 45D of the first golfer 5. The gender input part 60d is for inputting the gender 45E of the first golfer 5. The handicap input part 60e is for inputting the handicap 45F of the first golfer 5. These pieces of the unique information may be inputted, for example, directly by using the language input system, selectively with a pulldown menu or the like, or by the voice of the first golfer 5 to these input parts 60b to 60e.

On the unique information input screen 60 of the present embodiment, the golfer number (ID) 45A is displayed. While the golfer number 45A of the present embodiment is automatically assigned by the computer 3 (shown in FIG. 1 and FIG. 3), the number may be directly inputted by the first golfer 5 (shown in FIG. 1) under a restriction not allowing an overlap with another golfer number 45A.

At Step S4 in the present embodiment, the unique information inputted by the first golfer 5 is transmitted to the computer 3 (shown in FIG. 1) when the first golfer 5 (shown in FIG. 1) touches or presses a transmission button 60f displayed on the unique information input screen 60. Then, the unique information is received by the computer 3, and the records 44 including the unique information of the first golfer 5 are registered in the unique information table 43 (database) shown in FIG. 4.

At Step S4, for the first golfer 5 whose unique information has already been inputted to the unique information table 43, a login screen (not shown) may be displayed to prompt the golfer to input the golfer number (ID) 45A and a password (not shown), for example. With this, the computer 3 (shown in FIG. 3) can acquire the unique information of the first golfer 5 from the unique information table 43 based on the golfer number 45A.

### Import of First Needs Information

Next, in the information providing method of the present embodiment, first needs information, which is needs information requested by the first golfer 5 (shown in FIG. 1) from among the pieces of the needs information of multiple types, is imported into the computer 3 (shown in FIG. 1 and FIG. 3) (Step S5). In the present embodiment, the first needs information import part 42F of the computer 3 shown in FIG. 3 is read into the work memory 39. Then, with the first needs information import part 42F executed by the arithmetic unit 37, the computer 3 is caused to function as means for importing the first needs information.

In the present embodiment, the first needs information import part 42F (computer 3) shown in FIG. 3 transfers a signal via the communication network 4 shown in FIG. 1 to the portable terminal 2 to cause the portable terminal 2 shown in FIG. 2 to display the first golf swing information input screen on the display 16 threof.

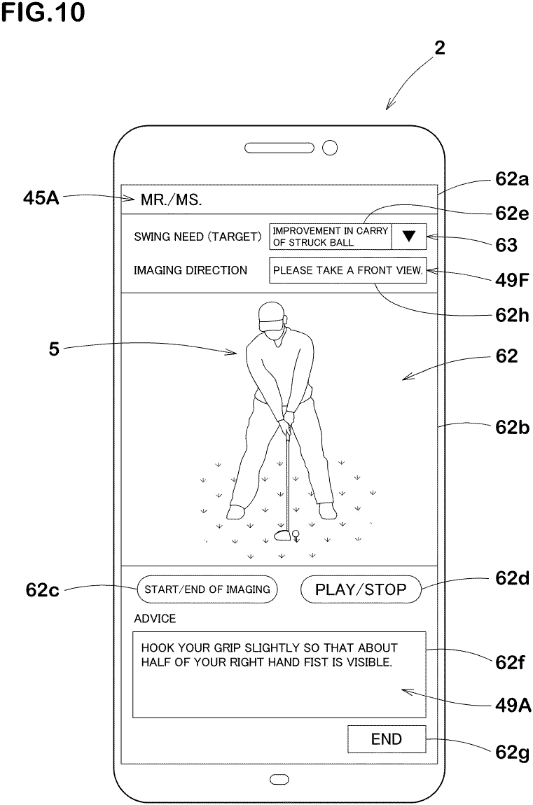

FIG. 10 is a diagram depicting a first golf swing information input screen 62 of the present embodiment. The first golf swing information input screen 62 is for taking an image of a golf swing (first golf swing information 53A (shown in FIG. 6)) of the first golfer 5 shown in FIG. 1. The first golf swing information input screen 62 includes, for example, a golfer name display part 62a, a taken-image display part 62b, an imaging start/end button 62c, a play/stop button 62d, a first needs input part 62e, an advice display part 62f, an end button 62g, and an imaging-direction instructing part 62h.

The golfer name display part 62a displays the golfer name (name of the first golfer 5 (shown in FIG. 1) stored in the item "golfer name" of the unique information table 43 shown in FIG. 4. The taken-image display part 62b displays the data (image) inputted from the input unit 6 (in the present example, the camera 10) shown in FIG. 2. The imaging start/end button 62c is to start and end taking an image of a golf swing of the first golfer 5. The play/stop button 62d is to play or stop the taken image of the golf swing.

The first needs input part 62e is to allow the first golfer 5 to input his or her needs (first needs information 63) regarding the golf swing. The first needs information 63 may be inputted, for example, directly by using a language input system, selectively with a pulldown menu or the like, or by the voice of the first golfer 5. The advice display part 62f is for displaying the advice information 49A for the first golfer 5. The end button 62g is to end the information providing method. The imaging-direction instructing part 62h is for displaying the instruction information regarding the imaging direction of the golf swing of the first golfer 5.

At Step S5 in the present embodiment, the first golfer 5 (shown in FIG. 1) inputs the first needs information 63 through the first needs input part 62e displayed on the first golf swing information input screen 62. On the first needs input part 62e, the above-described pieces of the needs information of the multiple types are displayed by using a pulldown menu or the like. Then at Step S5, the needs (first needs information 63) of the first golfer 5 is selected from these pieces of the needs information of the multiple types.

At Step S5 in the present embodiment, the first needs information 63 is transmitted to the computer 3 via the communication network 4 shown in FIG. 1 when an input of the first needs information 63 is determined in the first needs input part 62e. Then, the first needs information 63 is received by the computer 3. If the input of the first needs information 63 is changed, the changed first needs information 63 may be transmitted to the computer 3.

The first needs information import part 42F causes the first needs information 63 to be stored in the work memory 39 of the computer 3. Thereby, at Step S5, it is possible that the first needs information 63 requested by the first golfer 5 is imported into the computer 3 (shown in FIG. 1).

### Input of First Golf Swing Information

Next, in the information providing method of the present embodiment, the first golf swing information 53A (shown in FIG. 6), which is image data of the golf swing of the first golfer 5, is inputted to the computer 3 (shown in FIG. 1 and FIG. 3) (Step S6).

In the present embodiment, the portable terminal 2 is caused to function as means for acquiring the first golf swing information 53A (shown in FIG. 6) by the arithmetic unit 17 executing the information providing part 22A of the portable terminal 2 shown in FIG. 2. Further, in the present embodiment, the first golf swing information input part 42E of the computer 3 shown in FIG. 3 is read into the work memory 39. Then, the computer 3 is caused to function as means for inputting the first golf swing information 53A to the first golf swing information storage part 41C by the arithmetic unit 37 executing the first golf swing information input part 42E.

In the present embodiment, the first golf swing information input part 42E (computer 3) shown in FIG. 3 transfers a signal via the communication network 4 shown in FIG. 1 to the portable terminal 2 to cause the first golf swing information input screen 62 shown in FIG. 10 to be displayed on the display 16 of the portable terminal 2 shown in FIG. 2.

At Step S6 in the present embodiment, firstly, the first golf swing information input part 42E selects the record(s) 48 having the needs information 49C matching the first needs information 63 acquired at Step S5. The needs information 49C is stored in the item "needs" of the advice information table 47 shown in FIG. 5. Next, the first golf swing information input part 42E extracts the imaging direction 49F stored in the item "required imaging direction" of the selected record 48. Then, based on the extracted imaging direction 49F, the first golf swing information input part 42E causes the imaging-direction instructing part 62h of the first golf swing information input screen 62 to display the instruction information of the imaging direction of the golf swing. It should be noted that the imaging direction 49F may be outputted as voice information.

Next, at Step S6 in the present embodiment, based on the instructed imaging direction 49F, the camera 10 (shown in FIG. 2) of the portable terminal 2 is oriented to the first golfer 5 before a golf swing as shown in FIG. 1, for example. The portable terminal 2 may be held on a tripod 20, a caddie bag, or the like, for example.

Next, at Step S6 in the present embodiment, the imaging start/end button 62c is pushed or touched before the first golfer 5 starts a golf swing. Further, the imaging start/end button 62c is pressed or touched after the first golfer 5 finishes the golf swing. Thereby, an image of the golf swing of the first golfer 5 is taken as a moving image at Step S6. Image taking may be started and ended by the first golfer 5 or an accompanying person of the first golfer 5, or the like. Further, the portable terminal 2 may start and end imaging by detecting a golf swing of the first golfer 5.

In the present embodiment, an image of a golf swing is taken based on the required imaging direction 49F. Therefore, in the present embodiment, an image of a golf swing required to identify each of the swing attention points 49D (shown in FIG. 5) can be reliably taken. In the present embodiment, if the imaging directions 49F includes both front and rear, it is preferred that an image of a golf swing be taken simultaneously by using two or more portable terminals 2. However, an image of a golf swing from the front and an image of a golf swing from the rear may be separately taken.

The first golf swing information 53A is transmitted (provided) to the computer 3 via the communication network 4 shown in FIG. 1. This allows the computer 3 to acquire the first golf swing information 53A. Further, in the present embodiment, the imaging direction 53D and the imaging date and time 53E when the first golf swing information 53A is acquired are transmitted to the computer 3. As the imaging direction 53D, the instructed imaging direction 49F may be used, or the imaging direction may be automatically acquired from position information by GPS or the like. Furthermore, the imaging date and time 53E can be acquired from a timepiece incorporated in the portable terminal 2 or the like.

After receiving the above-described information, the first golf swing information input part 42E (shown in FIG. 3) generates a new record 52 on the first golf swing table 51 shown in FIG. 6. Further, the first golf swing information input part 42E inputs the received first golf swing information 53A, imaging direction 53D, and imaging date and time 53E to the items "first golf swing information", "imaging direction", and "imaging date and time", respectively, of the new record 52. Furthermore, the first golf swing information input part 42E inputs the golfer number 45A stored in the unique information table 43 shown in FIG. 5 to the item "golfer number" of the new record 52. It should be noted that the first swing number 53B automatically numbered by the first golf swing information input part 42E is inputted to the item "first swing number".

### Retrieval of First Reference Golf Swing Information

Next, in the information providing method of the present embodiment, the computer 3 (shown in FIG. 1 and FIG. 3) retrieves first reference golf swing information from among the plurality of pieces of reference golf swing information 56A shown in FIG. 7 based on the first needs information 63 (shown in FIG. 10) (Step S7). The first reference golf swing information is one piece of the reference golf swing information 56A most relevant to the first needs information selected from among the plurality of pieces of reference golf swing information 56A.

In the present embodiment, the first reference golf swing information retrieving part 42G of the computer 3 shown in FIG. 3 is read into the work memory 39. Then, with the first reference golf swing information retrieving part 42G executed by the arithmetic unit 37, the computer 3 is caused to function as means for retrieving first reference golf swing information 65.

At Step S7 in the present embodiment, firstly, the first reference golf swing information retrieving part 42G acquires the first needs information 63 imported at Step S5. Next, the first reference golf swing information retrieving part 42G selects the record 55 in which the acquired first needs information 63 (shown in FIG. 10) and the needs information 56C stored in the item "needs" of the reference golf swing table 54 match. Then, the first reference golf swing information retrieving part 42G retrieves the reference golf swing information 56A stored in the item "reference golf swing information" of the selected record 55 as the first reference golf swing information 65. In the present embodiment, the reference golf swing information 56A from an advanced golfer with higher skill than the first golfer 5 is retrieved as the first reference golf swing information 65. This allows comparison of golf swings between the first golfer 5 and the advanced golfer.

At Step S7 of the present embodiment, it is preferred that the record 55 in which the imaging direction 56D matches the imaging direction 53D of the above-described record 52 on the first golf swing table 51 is selected in the reference golf swing table 54. Therefore, the imaging directions between the first reference golf swing information 65 and the first golf swing information 53A match, thereby, a difference between the first golfer's swing and the advanced golfer's swing can be reliably extracted at Step S8 described later below.

It should be noted that when a plurality of pieces of the reference golf swing information 56A can be selected, one piece of reference golf swing information 56A may be selected in a random manner, or the reference golf swing information 56A matching a unique predisposition (for example, age) of the first golfer 5 may be selected. The first reference golf swing information 65 is read into the work memory 39 of the computer 3.

### Extraction of Difference in Golf Swings

Next, in the information providing method of the present embodiment, the computer 3 (shown in FIG. 1 and FIG. 3) extracts a difference in golf swings between the first reference golf swing information 65 and the first golf swing information 53A (Step S8). In the present embodiment, regarding the plurality of swing attention points 49D (shown in FIG. 5) corresponding to the first needs information 63 (shown in FIG. 10), a difference in golf swings between the first reference golf swing information 65 and the first golf swing information 53A is extracted.

In the present embodiment, the difference extraction part 42H of the computer 3 shown in FIG. 3 is read into the work memory 39. Then, with the difference extraction part 42H executed by the arithmetic unit 37, the computer 3 is caused to function as means for extracting a difference in golf swings.

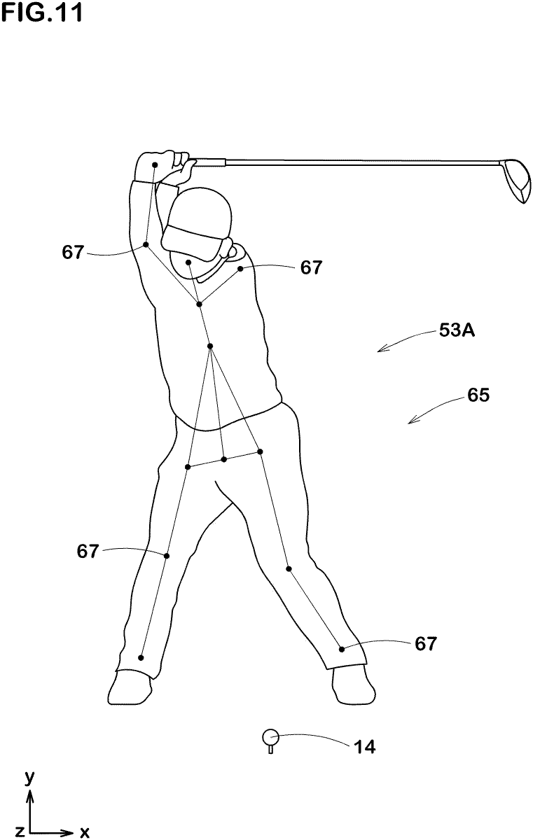

In the present embodiment, the difference in golf swings is identified by performing an image analysis on the first reference golf swing information 65 and the first golf swing information 53A. For the image analysis, image analysis software or the like based on a known image recognition technology (for example, CNN (Convolutional Neural Network) or the like) is used, for example. FIG. 11 is a diagram depicting a golf swing subjected to image analysis.

As shown in FIG. 11, feature points 67 such as, for example, the positions of the joints and the posture of the golfer can be identified by the image analysis on the golf swing. Based on these feature points 67, it is possible that a difference in golf swings is identified.

At Step S8 in the present embodiment, firstly, the difference extraction part 42H acquires a plurality of swing attention points 49D (shown in FIG. 5) corresponding to the first needs information 63 (shown in FIG. 10), and extracts a difference in the golf swings regarding the acquired plurality of swing attention points 49D.

In the present embodiment, the difference extraction part 42H (shown in FIG. 3) imports the first needs information 63 (shown in FIG. 10) imported at Step 5 and the first golf swing information 53A acquired at Step S6 into the work memory 39. Next, from among the plurality of the records 48 of the advice information table 47, the difference extraction part 42H selects the records 48 in which the first needs information 63 and the needs information 49C match. Then, the swing attention point 49D of each of the selected records 48 is acquired.

As shown in FIG. 5, when the first needs information 63 (shown in FIG. 10) is "improvement in carry of struck ball", the swing attention points "way of holding grip at address", "timing when the wrist cock is released at downswing", and "pause duration at swing top" are acquired as the swing attention points 49D. Then, at Step S8, based on a procedure described below, a difference in golf swings between the first reference golf swing information 65 and the first golf swing information 53A (may be hereinafter simply referred to as a "difference in golf swings") is extracted for each of the swing attention points 49D.

It should be noted that when there is a difference in constitution of the golfers, imaging areas, and so forth between the first reference golf swing information 65 and the first golf swing information 53A, it is preferred that at least one image data be corrected in advance so as to decrease the difference therebetween. This allows a difference in golf swings therebetween to be appropriately extracted.

When the first needs information 63 (shown in FIG. 10) is "suppression of slice of struck ball", as shown in FIG. 5, the swing attention points "way of holding grip at address", "amount of movement of left knee at downswing", and "swing path" are acquired as the swing attention points 49D. Then, at Step S8, based on the procedure described below, a difference in golf swings is extracted for each of these swing attention points 49D.

When the first needs information 63 (shown in FIG. 10) is "improvement in top strike", as shown in FIG. 5, the swing attention points "position of golfer's head at address" and "amount of opening of left underarm at impact" are acquired as the swing attention points 49D. Then, at Step S8, based on the procedure described below, a difference in golf swings is extracted for each of these swing attention points 49D. In the following, one example of the difference in golf swings is described.

### Difference (Way of Holding Grip at Address)

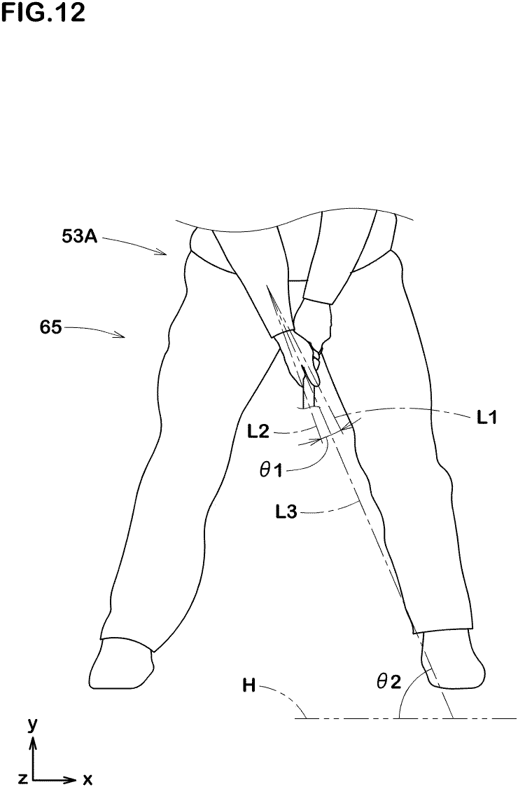

FIG. 12 is a diagram describing a difference in golf swings regarding the swing attention point 49D "way of holding grip at address". In the present embodiment, when a difference in golf swings is extracted for the swing attention point 49D "way of holding grip at address", a difference in "degree of weakness" between the first reference golf swing information 65 and the first golf swing information 53A is extracted.

The degree of weakness indicates a degree of a weak grip of the golfer at address. In the present embodiment, the degree of weakness is acquired for each of the first reference golf swing information 65 and the first golf swing information 53A, and a difference in the degree of weakness therebetween is extracted.

The degree of weakness can be acquired as appropriate if the degree of the weak grip at address can be converted into numerical form. In the present embodiment, firstly, in the first reference golf swing information 65 and the first golf swing information 53A, a still image of the golfer (first golfer 5) at address is acquired. Next, in the acquired still image, a middle line L3 bisecting a V-shaped angle θ1 where a first line L1 of the right thumb intersects a second line L2 of the right index finger is acquired. The first line L1 and the second line L2 can be each identified by a center line of the finger in a width direction. Then, an angle θ2 between the middle line L3 and a horizontal line H (x-axis direction) is acquired as the degree of weakness. The smaller the angle θ2, the larger the degree of weakness is. The positions of the thumb and the index finger of the golfer (first golfer 5) and so forth can be identified by performing an image analysis on the first reference golf swing information 65 and the first golf swing information 53A.

In the present embodiment, as the difference in golf swings regarding the swing attention point 49D "way of holding grip at address", a difference (absolute value) between the degree of weakness (angle θ2) of the first reference golf swing information 65 and the degree of weakness (angle θ2) of the first golf swing information 53A is acquired. The larger the difference, the larger the gap between the golf swing of the first golfer 5 and the golf swing of the target for comparison with regard to the above-described swing attention point 49D.

### Difference (Timing When Wrist Cock is Released at Downswing)

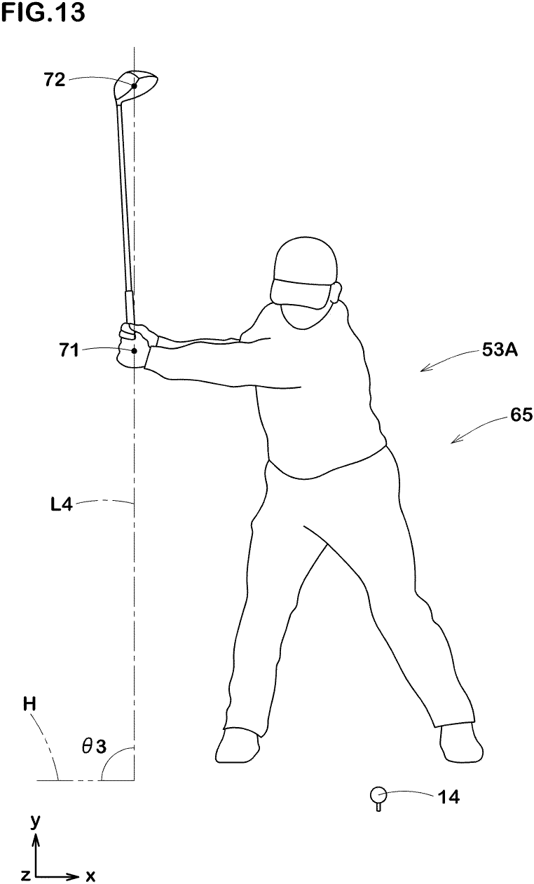

FIG. 13 is a diagram illustrating a difference in golf swings regarding the swing attention point 49D "timing when the wrist cock is released at downswing." In the present embodiment, when a difference in golf swings is extracted for the swing attention point 49D "timing when the wrist cock is released at downswing", a difference in "wrist-cock degree" between the first reference golf swing information 65 and the first golf swing information 53A is extracted.

The wrist-cock degree can be acquired as appropriate if the timing when the wrist cock is released at downswing can be converted into numerical form. In the present embodiment, firstly, a still image is acquired in which a center position (centroid) 71 of the back of the left hand of the golfer is positioned on a rightmost side (leftmost side in the drawing) in the horizontal direction (x-axis direction) from the start to the end of a downswing of a golf swing. Next, a straight line L4 connecting the center position 71 of the back of the left hand of the golfer and the center position (centroid) of the clubhead is identified, and an angle θ3 between the straight line L4 and the horizontal line H (x-axis direction) is identified as the wrist-cock degree. The smaller the angle θ3, the smaller the wrist-cock degree is, which indicates earlier timing of the release of the wrist cock. The wrist-cock degree is acquired for each of the first reference golf swing information 65 and the first golf swing information 53A. It should be noted that the center position 71 of the back of the left hand and the center position 72 of the clubhead, and so forth are identified as appropriate by image analysis using the above-described image analysis software or the like.

In the present embodiment, as the difference in golf swings regarding the swing attention point 49D "timing when the wrist cock is released at downswing", a difference (absolute value) between the wrist-cock degree (angle θ3) of the first reference golf swing information 65 and the wrist-cock degree of the first golf swing information 53A is acquired. The larger the difference, the larger the gap between the golf swing of the first golfer 5 and the golf swing as a target for comparison with respect to the above-described swing attention point 49D.

### Difference (Pause Duration at Swing Top)

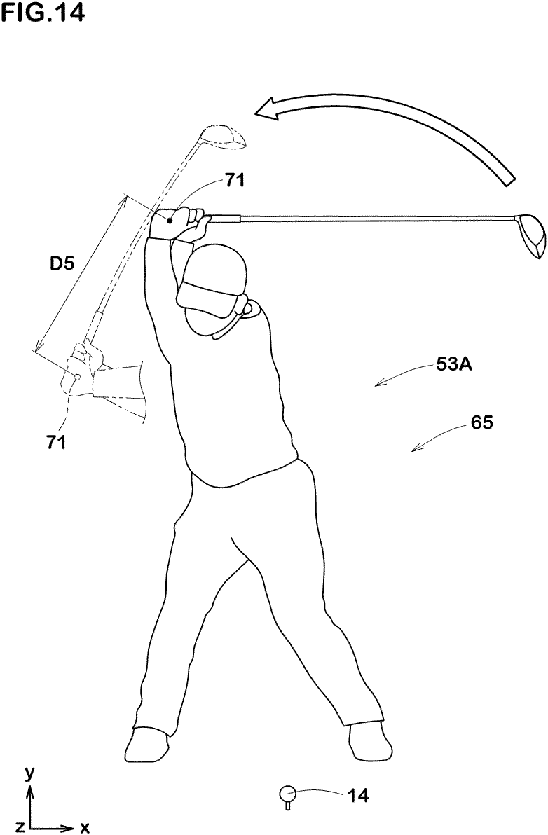

FIG. 14 is a diagram illustrating the difference in golf swings regarding the swing attention point 49D "pause duration at swing top". In the present embodiment, when a difference in golf swings is extracted for the swing attention point 49D "pause duration at swing top", a difference in "amount of movement from the top" between the first reference golf swing information 65 and the first golf swing information 53A is extracted.

"Amount of movement from the top" can be acquired as appropriate if the pause duration at swing top can be converted into numerical form. In the present embodiment, firstly, a still image (of the top swing) is acquired in which the center position 71 of the back of the left hand of the golfer has reached the highest position in a vertical direction (y-axis direction) from the start to the end of a golf swing. Further, a still image (indicated by two-dot-chain lines) after a lapse of a predetermined time (in the present example, 0.5 seconds) from the time when the center position 71 reached the highest position is acquired. In these still images, an amount of movement D5 of the center position 71 of the back of the left hand is identified as "amount of movement from the top". The larger the amount of movement D5, the smaller the pause duration at swing top. It should be noted that the center position 71 of the back of the left hand and so forth are easily identified by image analysis using the above-described image analysis software or the like. Furthermore, the amount of movement from the top may be identified two-dimensionally (in the x-axis direction and the y-axis direction), but is preferably identified three-dimensionally (in the x-axis direction, the y-axis direction, and the z-axis direction).

In the present embodiment, as the difference in golf swings regarding the swing attention point 49D "pause duration at swing top", a difference (absolute value) between the amount of movement D5 of the first reference golf swing information 65 and the amount of movement D5 of the first golf swing information 53A is acquired. The larger the difference, the larger the gap between the golf swing of the first golfer 5 and the golf swing as the target for comparison regarding the above-described swing attention point 49D.

### Difference (Amount of Movement of Left Knee at Downswing)

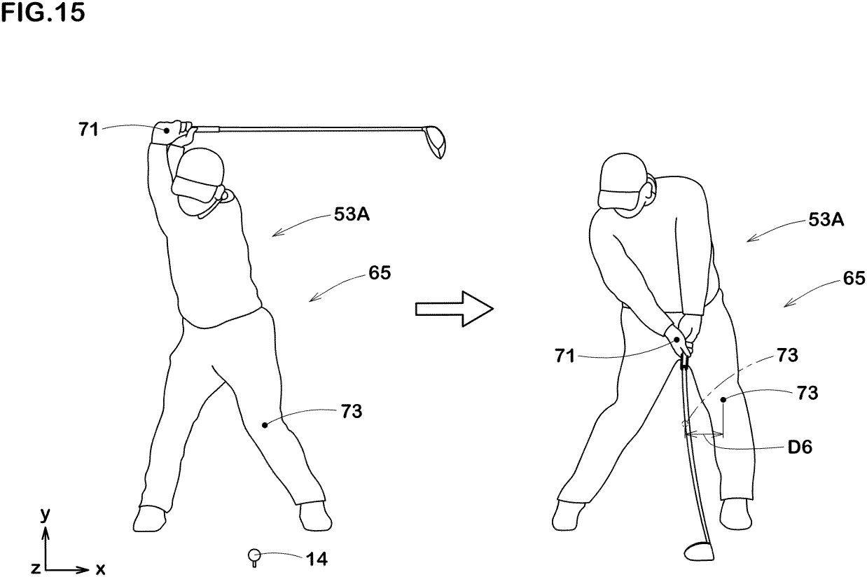

FIG. 15 is a diagram describing a difference in golf swings regarding the swing attention point 49D "amount of movement of left knee at downswing". In the present embodiment, when a difference in golf swings is extracted for the swing attention point 49D "amount of movement of left knee at downswing", a difference in "amount of movement of the left knee" between the first reference golf swing information 65 and the first golf swing information 53A is extracted.

In the present embodiment, a still image (of the swing top) (on a left side in the drawing) is acquired in which the center position 71 of the back of the left hand of the golfer has reached the highest position in the vertical direction (y-axis direction). Further, a still image (at impact) (on a right side in the drawing) is acquired in which the center position 71 of the back of the left hand of the golfer has reached the lowest position (at impact) after reaching the highest position. Then, in these still images, an amount of movement D6 in the horizontal direction (x-axis direction) of a center position (centroid) 73 of the left knee of the golfer is acquired. The larger the amount of movement D6, the larger the amount of movement of the left knee from the swing top to impact is. It should be noted that the center position 73 of the left knee is identified as appropriate by image analysis using the above-described image analysis software or the like.

In the present embodiment, as the difference in golf swings regarding the swing attention point 49D "amount of movement of left knee at downswing", a difference (absolute value) between the amount of movement D6 of the first reference golf swing information 65 and the amount of movement D6 of the first golf swing information 53A is acquired. The larger the difference, the larger the gap between the golf swing of the first golfer 5 and the golf swing of the target for comparison with respect to the above-described swing attention point 49D.

### Difference (Swing Path)

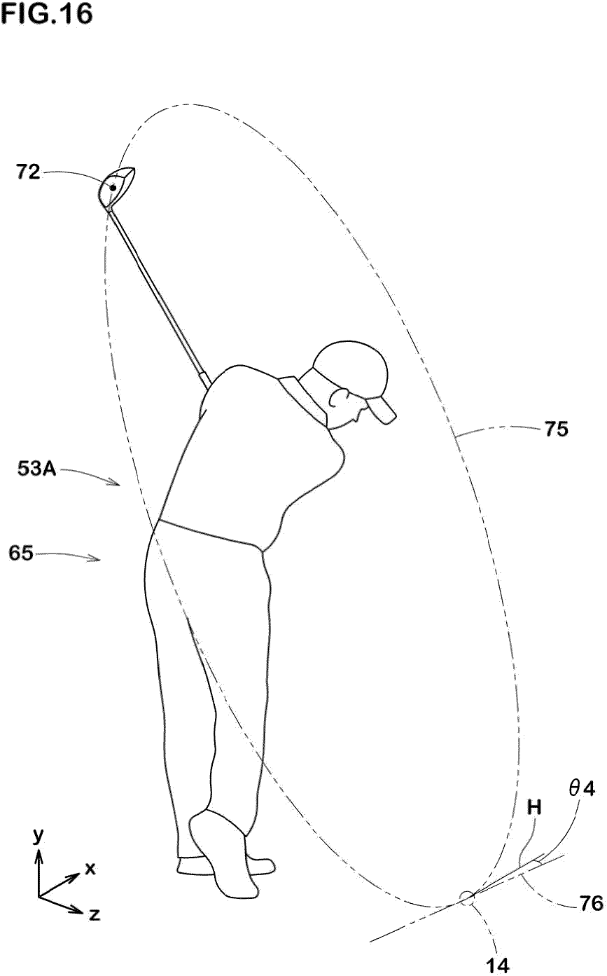

FIG. 16 is a diagram illustrating the difference in golf swings regarding the swing attention point 49D "swing path". In the present embodiment, when a difference in golf swings is extracted for the swing attention point 49D "swing path", a difference in "angle of approach of the head at impact" between the first reference golf swing information 65 and the first golf swing information 53A is extracted.

"Angle of approach of the head at impact" can be acquired as appropriate if the swing path can be converted into numerical form. In the present embodiment, the first reference golf swing information 65 and the first golf swing information 53A whose images are taken from the rear of the golfer are used. Further, in the present embodiment, a path 75 of the center position 72 of the clubhead is acquired from the start to the end of a golf swing. Then, an angle θ4 between a tangent line 76 of the path 75 at the position of the ball 14 (indicated by a two-dot-chain line) and the horizontal line H (x-axis direction) is identified as the "angle of approach at impact". In the present embodiment, the angle of approach (angle θ4) at inside-out is taken as positive, and an angle of approach (angle θ4) at outside-in is taken as negative. It should be noted that the center position 72 of the clubhead and so forth are easily identified by image analysis using the above-described image analysis software or the like.

In the present embodiment, as the difference in golf swings regarding the swing attention point 49D "angle of approach of the head at impact", a value obtained by subtracting an angle of approach (angle θ4) of the first golf swing information 53A from an angle of approach (angle θ4) of the first reference golf swing information 65 is acquired. The larger the difference, the larger the gap between the golf swing of the first golfer 5 and the golf swing of the target for comparison for the above-described swing attention point 49D, which can be determined that the first golfer has a tendency of outside-in.

### Difference (Position of Golfer's Head at Address)

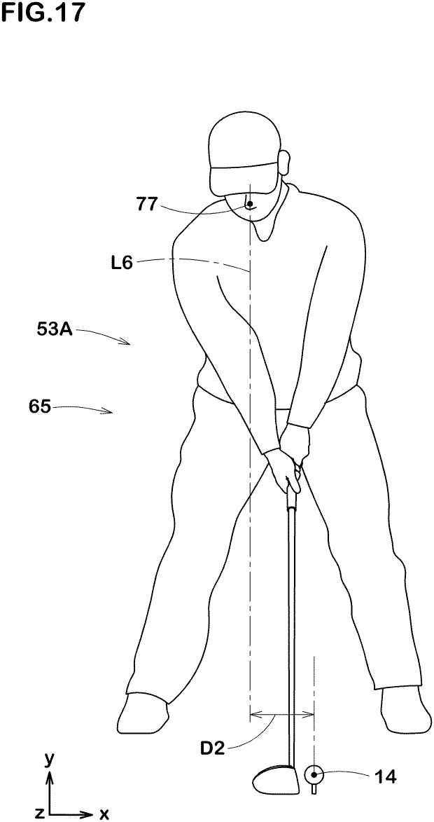

FIG. 17 is a diagram illustrating the difference in golf swings regarding the swing attention point 49D "position of golfer's head at address". In the present embodiment, when the difference in golf swings is extracted for the swing attention point 49D "position of golfer's head at address", a difference in "clearance (distance) between the golfer's head and the ball" between the first reference golf swing information 65 and the first golf swing information 53A is extracted.

The clearance between the golfer's head and the ball can be acquired as appropriate if the position of the head at address can be converted into numerical form. In the present embodiment, firstly, a still image of the golfer (first golfer 5) at address is acquired for each of the first reference golf swing information 65 and the first golf swing information 53A. Next, in each of the acquired still images, a straight line L6 perpendicular to the ground (in the y-axis direction) from a center position (centroid) 77 of the nose of the golfer is acquired. Then, a distance D2 in the horizontal direction (x-axis direction) between the straight line L6 and the ball (center position) 14 is identified as the clearance between the golfer's head and the ball. in In the present embodiment, the clearance (distance D2) is regarded as positive when the position of the golfer's head is on the left side of the ball 14 (right side in the drawing) and the clearance is regarded as negative when the position of the golfer's head is on the right side of the ball 14 (left side in the drawing). The longer the distance D2, the more the head position is to the left side (right side in the drawing) of the ball 14 at address. It should be noted that the center position 77 of the nose or the like is identified as appropriate by image analysis using the above-described image analysis software or the like.

In the present embodiment, as a difference in golf swings regarding the swing attention point 49D "position of golfer's head at address", a difference (absolute value) between the clearance (distance D2) of the first reference golf swing information 65 and the clearance (distance D2) of the first golf swing information 53A is acquired. The larger the difference, the larger the gap between the golf swing of the first golfer 5 and the golf swing of the target for comparison is regarding the above-described swing attention point 49D.

### Difference (Amount of Opening of Left Underarm at Impact)

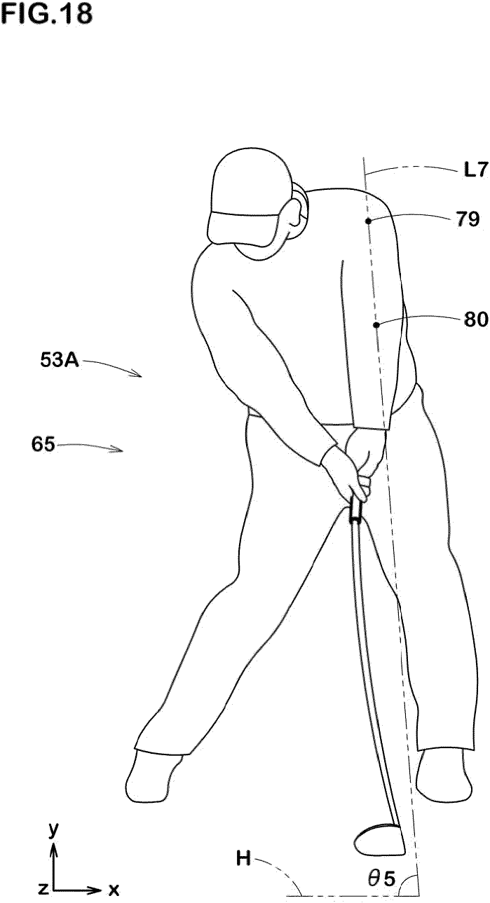

FIG. 18 is a diagram illustrating the difference in golf swings regarding the swing attention point 49D "amount of opening of left underarm at impact". In the present embodiment, when the difference in golf swings is extracted for the swing attention point 49D "amount of opening of left underarm at impact", a difference in "amount of opening of the left underarm" between the first reference golf swing information 65 and the first golf swing information 53A is extracted.

In the present embodiment, a still image at impact is acquired from the start to the end of a golf swing. In this still image, an angle θ5 between the horizontal line H (x-axis direction) and a straight line L7 connecting a position 79 of the left shoulder of the golfer and a position 80 of the left elbow of the golfer is acquired as an amount of opening of the left underarm. The smaller the amount of opening (angle θ5), the larger the left underarm of the golfer at impact is open. It should be noted that the position 79 of the left shoulder and the position 80 of the left elbow and so forth are identified as appropriate by image analysis using the above-described image analysis software or the like.

In the present embodiment, as the difference in golf swings regarding the swing attention point 49D "amount of opening of left underarm at impact", a value obtained by subtracting an amount of opening (angle θ5) of the left underarm of the first reference golf swing information 65 from the amount of opening (angle θ5) of the left underarm of the first golf swing information 53A is acquired. The larger the difference, the larger the gap between the golf swing of the first golfer 5 and the golf swing serving of the target for comparison is regarding the above-described swing attention point 49D, which indicates that the left underarm of the first golfer 5 is open.

In this manner, at Step S8 in the present embodiment, as for the plurality of swing attention points 49D (shown in FIG. 5) matching the first needs information 63 (shown in FIG. 10), the difference in golf swings between the first reference golf swing information 65 and the first golf swing information 53A is extracted. The extracted difference in golf swings is stored in the work memory of the computer 3.

### Provision of Advice Information

Next, in the information providing method of the present embodiment, the computer 3 (shown in FIG. 1 and FIG. 3) selects the advice information 49A and provides the first golfer 5 (shown in FIG. 1) with the selected advice information 49A (Step S9). At Step S9 in the present embodiment, the advice information 49A is selected based on the magnitude of the difference in golf swings and the information provision priority 49E shown in FIG. 5 (in the present example, the first priority 50).

In the present embodiment, the advice information providing part 42I of the computer 3 shown in FIG. 3 is read into the work memory 39. Then, with the advice information providing part 42I executed by the arithmetic unit 37, the computer 3 is caused to function as means for providing advice information to the first golfer 5.

At Step S9 in the present embodiment, firstly, the advice information providing part 42I (shown in FIG. 3) selects the records 48 where the needs information 49C matching the first needs information 63 (shown in FIG. 10) is inputted from among the plurality of records 48 of the advice information table 47 shown in FIG. 5. Then, for each of the swing attention points 49 of the selected records 48, the information provision priority 49E (first priority 50) is acquired.

As shown in FIG. 5, when the first needs information 63 (shown in FIG. 10) is "improvement in carry of struck ball", the number " 1" is acquired as the first priority 50 of "way of holding grip at address". Similarly, the number "3" is acquired as the first priority 50 of "timing when the wrist cock is released at downswing", and the number "2" is acquired as the first priority 50 of "pause duration at swing top".

Next, at Step S9 in the present embodiment, the advice information providing part 42I (shown in FIG. 3) determines whether the difference in golf swings is larger than a predetermined threshold as for the plurality of swing attention points 49D. Each threshold is to determine whether the first golfer 5 (shown in FIG. 1) should improve the golf swing for each swing attention point 49D. Thus, the threshold is set for each swing attention point 49D. In the present embodiment, the swing attention point(s) 49D having the difference in golf swings larger than the threshold is (are) determined as the swing attention point(s) 49D to be improved for the first golfer 5.

When the first needs information 63 (shown in FIG. 10) is "improvement in carry of struck ball", for each of the swing attention points 49D (shown in FIG. 5) "way of holding grip at address", "timing when the wrist cock is released at downswing", and "pause duration at swing top", it is determined whether the difference in golf swings is larger than the threshold. The difference in golf swings regarding "way of holding grip at address" is the difference in the degree of weakness (angle θ2) shown in FIG. 12. The difference in golf swings regarding "timing when the wrist cock is released at downswing" is the difference in the wrist-cock degree (angle θ3) shown in FIG. 13. The difference in golf swings regarding "pause duration at swing top" is the difference in the amount of movement D5 from the top shown in FIG. 14. Then, the swing attention point(s) 49D with the difference in golf swings larger than the threshold is (are) identified.

Next, at Step S9 in the present embodiment, based on the magnitude of the difference in golf swings and the information provision priority 49E (first priority 50) shown in FIG. 5, the advice information 49A is selected from the advice information table 47.

In the present embodiment, when there is only one swing attention point 49D which has the difference in golf swings larger than the threshold, the advice information 49A of the record 48 where the one swing attention point 49D is stored is acquired from the advice information table 47. On the other hand, when there are multiple swing attention points with the difference in golf swings larger than the threshold, one swing attention point 49D having the highest first priority 50 (that is, the smallest numerical value) is selected. Then, the advice information 49A of the record 48 having the selected swing attention point 49D stored therein is acquired from the advice information table 47. It should be noted that if there is no swing attention point 49D with the difference in golf swings larger than the threshold, advice information indicating that the golf swing of the first golfer 5 is favorable (for example, "Good golf swing. Let's keep it going") may be generated in the present embodiment.

When the difference in golf swings is larger than the threshold for "way of holding grip at address", "timing when the wrist cock is released at downswing", and "pause duration at swing top", for example, "way of holding grip at address" with the highest priority is selected. Then, the advice information 49A " Hook your grip slightly so that about half of your right fist is visible." of the record 48 having the swing attention point 49D "way of holding grip at address" is acquired.

Next, at Step S9 in the present embodiment, the advice information providing part 42I (shown in FIG. 3) provides the selected advice information 49A to the first golfer 5 (shown in FIG. 1). In the present embodiment, firstly, the selected advice information 49A is transferred from the computer 3 shown in FIG. 1 via the communication network 4 to the portable terminal 2. Next, in the present embodiment, the information output part 22B of the portable terminal 2 shown in FIG. 2 is executed by the arithmetic unit 17. Therefore, the transferred advice information 49A is displayed in the advice display part 62f (shown in FIG. 10) of the first golf swing information input screen 62. Thereby, at Step S9, the advice information 49A can be provided to the first golfer 5. It should be noted that the advice information 49A may be outputted, for example, as voice information perceivable by the first golfer 5 via the loudspeaker 15 (shown in FIG. 2).

In the information providing method of the present embodiment, for the plurality of swing attention points 49D matching the first needs information 63 (shown in FIG. 10), the magnitude of a difference between the golf swing (shown in FIG. 6) of the first golfer 5 and the golf swing (shown in FIG. 7) serving as a target for comparison to achieve the need is acquired. Therefore, with respect to the golf swing of a target for comparison, the swing attention point 49D to be improved in the golf swing of the first golfer 5 is identified, for example.

Further, in the information providing method of the present embodiment, based on the difference in golf swings and the information provision priority 49E (shown in FIG. 5), one piece of the advice information 49A regarding the swing attention point 49D with a high degree of importance is selected from the swing attention points 49D to be improved. This allows the first golfer 5 has a golf lesson based on the advice information 49A regarding the swing attention point 49D with the high degree of importance, similarly to a lesson at a golf school. In this manner, it is possible that the information providing method of the present embodiment provides the appropriate advice information 49A in accordance with the need and golf swing of the first golfer 5.

On the provided advice information 49A, the first reference golf swing information 65 used to extract the difference between the first golf swing information 53A and the first golfer's golf swing may be displayed. Further, a practice drill (not shown) useful in repeated practice based on the advice information 49A may be displayed. This allows the first golfer 5 to practice the golf swing while watching the first reference golf swing information 65 and the practice drill.

The provided advice information 49A may be evaluated by the first golfer 5. With such an evaluation, the provided advice information 49A can be fed back in the information providing method of the present embodiment. This is useful in improving provision of advice information in the future.

### End Determination Step

Next, in the information providing method of the present embodiment, it is determined whether an instruction for ending the information providing method has been provided (Step S10). At Step S10 in the present embodiment, with the end determination part 42J of the computer 3 shown in FIG. 3 read into the work memory 39 and executed by the arithmetic unit 37, the computer 3 is caused to function as means for determining whether the end instruction has been provided.

In the present embodiment, with the end button 62g displayed on the display 16 shown in FIG. 10 being pressed (touched) by the first golfer 5, the end instruction is provided. Further, the end instruction may be provided based on voice information uttered by the first golfer 5 (voice information regarding the end instruction), for example.

At Step S10, when it is determined that the end instruction has been provided ("Yes" at Step S10), the series of processes of the information providing method ends. On the other hand, when it is determined at Step S10 that the end instruction has not been provided ("No" at Step S10), Step S5 to Step S10 are executed again. Thereby, in the information providing method of the present embodiment, useful information (advice information 49A) suitable for the first golfer 5 shown in FIG. 1 can be continuously provided until the end instruction is made (during a golf play).

### Golfer-Oriented Information Providing Method (Second Embodiment)

In the above-described embodiment, as shown in FIG. 5, the first priority 50 is included as the information provision priority 49E. However, this is not meant to be restrictive. For example, a second priority (not shown) may be included for selecting the advice information 49A in descending order of a ratio of the difference in golf swings between the first reference golf swing information 65 and the first golf swing information 53A with respect to the plural swing attention points 49D.

The second priority is to provide the first golfer 5 who wishes to improve mainly the swing attention point 49D having a large difference from the first reference golf swing information 65 with the advice information 49A of the above-mentioned swing attention point 49D. The ratio of the difference in golf swings can be acquired as appropriate. A ratio obtained by dividing the difference in golf swings by the threshold set for the concerned difference (difference / threshold) may be acquired as a ratio of the difference in regard to the swing attention point 49D, for example. The ratio of difference configured as such is useful in comparing the degrees of the gap from the first reference golf swing information 65 having different scales.

### Golfer-Oriented Information Providing Method (Third Embodiment)

In the above-described embodiments, at Step S7 of retrieving the first reference golf swing information 65, the golf swing (reference golf swing information 56A) of the advance golfer with higher skill than the first golfer 5 is retrieved. However, this is not meant to be restrictive.

In the third embodiment, an ideal swing determined by the first golfer 5 may be retrieved as the first reference golf swing information 65. The ideal swing is not particularly restricted as long as it is determined by the first golfer 5. In this embodiment, an ideal golf swing of the first golfer 5 himself / herself which satisfied the need before the information providing method is implemented is retrieved as the first reference golf swing information 65. Herewith, in the information providing method of this embodiment, based on a difference between the current golf swing of the first golfer 5 and the golf swing which the first golfer 5 regards as ideal, it is possible to provide the advice information 49A which can enable the first golfer 5 to reproduce the ideal golf swing.

### Input of Needs Information of Golf Swing (Third Embodiment)

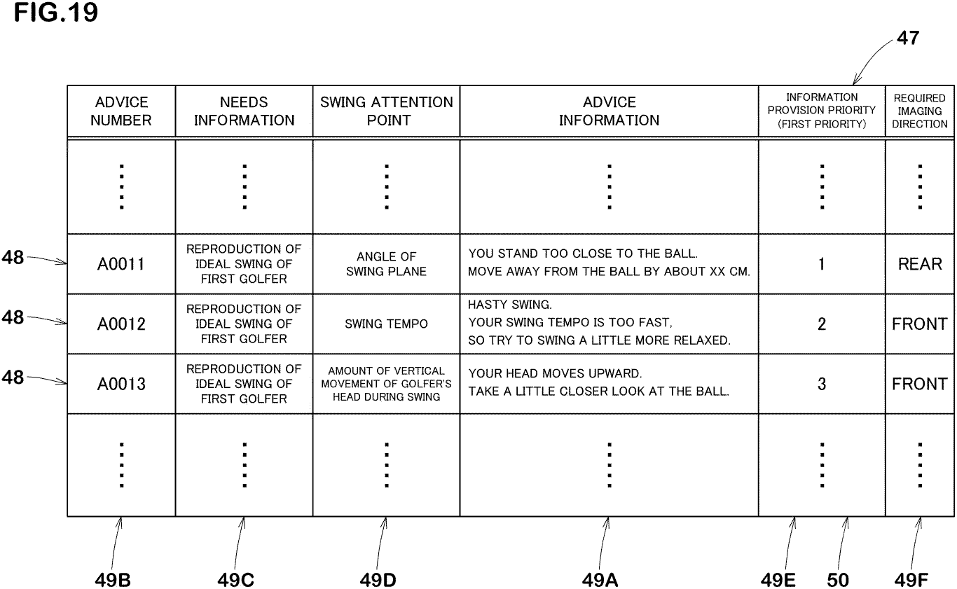

FIG. 19 is a diagram depicting the structure of the advice information table 47 of the third embodiment of the present invention. At Step S1 in this embodiment, "reproduction of ideal swing of first golfer" is inputted as the needs information 49C to the item "needs information" of the advice information table 47.

### Input of Swing Attention Points and Advice Information (Third Embodiment)

At Step S2 in this embodiment, in regards to the needs information 49C "reproduction of ideal swing of first golfer", a plurality of the swing attention points 49D (important technical points) for achieving a golf swing matching the first golfer's needs (needs information) are inputted.

The swing attention points 49D for achieving the "reproduction of ideal swing of first golfer" include, for example, "angle of swing plane", "swing tempo", and "amount of vertical movement of golfer's head during swing". At Step S2 in this embodiment, these swing attention points 49D are inputted in the item "swing attention point" of the records 48 having the "reproduction of ideal swing of first golfer" inputted therein as the needs information 49C in the advice information table 47. It should be noted that the swing attention points 49D are not limited this mode and only part of these swing attention points 49D may be inputted or other swing attention point(s) (not shown) may be further included.

The swing attention point 49D "angle of swing plane" is an angle of the swing plane at downswing. If this angle is large, the first golfer 5 shown in FIG. 1 unconsciously stands close to the ball 14 and there is a tendency that his or her ideal golf swing cannot be reproduced. Therefore, for the first golfer 5 having the need "reproduction of ideal swing of first golfer" and having a large angle of the swing plane, it is effective to provide a specific advice such as, for example, "You stand too close to the ball. Move away from the ball by about XX cm." as the advice information 49A. In this embodiment, the above-described advice information 49A is inputted in the item "advice information" of the record 48 having the needs information 49C "reproduction of ideal swing of first golfer" and the swing attention point 49D "angle of swing plane".

The swing attention point 49D "swing tempo" is identified by a duration from the start of a swing to impact. If this duration is short (i.e., tempo is fast), the first golfer 5 shown in FIG. 1 strikes the ball 14 in haste, and thus there is a tendency that the ideal swing cannot be reproduced. Therefore, for the first golfer 5 having the need "reproduction of ideal swing of first golfer" and having a fast swing tempo, it is effective to provide a specific advice such as, for example, "Hasty swing. Your swing tempo is too fast, so try to swing a little more relaxed." as the advice information 49A. In this embodiment, the above-described advice information 49A is inputted in the item "advice information" of the record 48 with the needs information 49C "reproduction of ideal swing of first golfer" and the swing attention point 49D "swing tempo".

The swing attention point 49D "amount of vertical movement of golfer's head during swing" is an amount of movement of the head of the first golfer 5 in a vertical direction from the start of a swing to impact. If the amount of upward movement of the head of the first golfer is large, there is a tendency that the first golfer 5 cannot take a look at the ball 14 properly and the ideal swing cannot be reproduced. Therefore, for the first golfer 5 having the need "reproduction of ideal swing of first golfer" and having a large amount of upward movement of his or her head, it is effective to provide a specific advice such as, for example, "Your head moves upward. Take a little closer look at the ball." as the advice information 49A. In this embodiment, the above-described advice information 49A is inputted in the item "advice information" of the record 48 with the needs information 49C "reproduction of ideal swing of first golfer" and the swing attention point 49D "amount of vertical movement of golfer's head during swing".

In order to achieve a swing satisfying the need, the above-described swing attention points 49D have priorities (degrees of importance) as to improvement. For example, in order to achieve the need "reproduction of ideal swing of first golfer", an improvement in "angle of swing plane" is regarded as most important for the first golfer 5 among the above-described swing attention points 49D. Next, for the first golfer 5 with a good (improved) "angle of swing plane", an improvement in "swing tempo" is more important than "amount of vertical movement of golfer's head during swing". Then, for the first golfer 5 with a good "angle of swing plane" and a good "swing tempo", it is possible that the need "reproduction of ideal swing of first golfer" is reliably achieved by improving the "amount of vertical movement of golfer's head during swing".

In this embodiment, the degree of importance of the advice information 49A for the "angle of swing plane" is the highest among the above-described swing attention points 49D. Thus, the number "1" is inputted in the item "information provision priority (first priority)" of the record 48 of the above-mentioned advice information 49A. Next, since the degree of importance of the advice information 49A for "swing tempo" is the second highest, the number "2" is inputted in the item "information provision priority (first priority)" of the record 48 of the advice information 49A. Next, since the degree of importance of the advice information 49A for the "amount of vertical movement of golfer's head during swing" is the third highest, the number "3" is inputted in the item "information provision priority (first priority)" of the record 48 of said advice information 49A. With the information provision priorities 49E (first priorities 50) configured as such being set in the advice information table 47, it is possible that the advice information 49A based on the information provision priorities 49E is provided at Step S9 described below.

In the needs information 49C "reproduction of ideal swing of first golfer", in order to identify the swing attention point 49D "angle of swing plane", it is preferred that the image of the golf swing is taken from the rear. Thus, "rear" is inputted in the item "required imaging direction" of the record 48 of the above-mentioned swing attention point 49D. On the other hand, in order to identify the swing attention points 49D "swing tempo" and "amount of vertical movement of golfer's head during swing", it is preferred that the image of the golf swing is taken from the front. Thus, "front" is inputted in the item "required imaging direction" of the record 48 of each of these swing attention points 49D.

### Input of Reference Golf Swing Information (Third Embodiment)

At Step S3 of inputting the reference golf swing information, the ideal golf swing determined by the first golfer 5 is inputted to the reference golf swing table 54 as the reference golf swing information 56A. It is preferred that this reference golf swing information 56A includes the record 55 having an image of the reference golf swing information 56A taken from the front and an image of the reference golf swing information 56A taken from the rear.

### Retrieval of First Reference Golf Swing Information (Third Embodiment)

At Step S7 in this embodiment, when the "reproduction of ideal swing of first golfer" is imported as the first needs information 63 (shown in FIG. 10), the ideal swing (reference golf swing information 56A) determined by the first golfer 5 is retrieved as first reference golf swing information. The ideal swing can be determined by the first golfer 5 from multiple pieces (images) of the reference golf swing information 56A displayed on the portable terminal 2, for example. The first reference golf swing information 65 is read into the work memory 39 of the computer 3.

### Extraction of Difference in Golf Swings (Third Embodiment)

At Step S8 in the third embodiment, when the first needs information 63 (shown in FIG. 10) is the "reproduction of ideal swing of first golfer" (not shown), the "angle of swing plane", "swing tempo", and "amount of vertical movement of golfer's head during swing" are acquired as the swing attention points 49D. Then, at Step S8, based on a procedure described below, a difference in golf swings regarding each of these swing attention points 49D is extracted.

### Difference (Angle of Swing Plane)

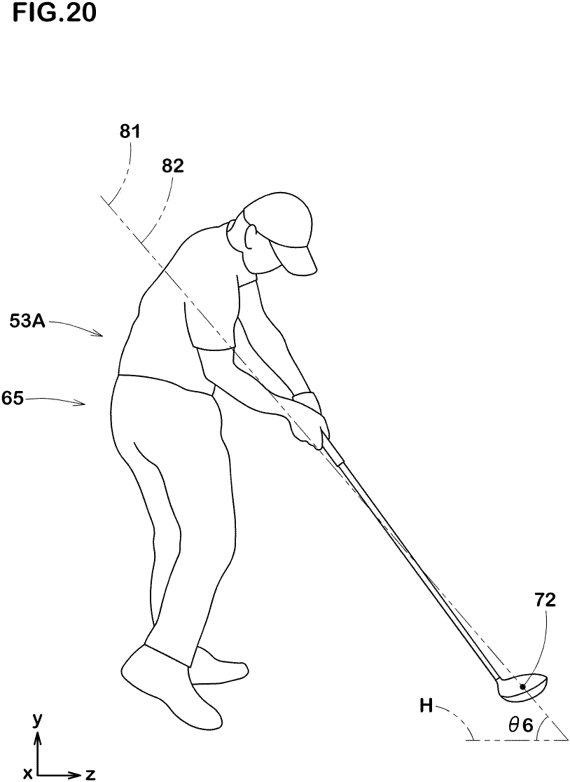

FIG. 20 is a diagram illustrating the difference in golf swings regarding the swing attention point 49D "angle of swing plane". In this embodiment, when the difference in golf swings regarding the swing attention point 49D "angle of swing plane" is extracted, a difference in the "angle of swing plane" between the first reference golf swing information 65 and the first golf swing information 53A is extracted.

The angle of the swing plane can be acquired as appropriate if the angle of the swing plane at downswing can be converted into numerical form. In this embodiment, images of the golfers taken from their rear are used as the first reference golf swing information 65 and the first golf swing information 53A. Further in this embodiment, a path 81 of the center position 72 of the clubhead is acquired from the top swing to impact. Then, an angle θ6 between a tangent line 82 of the path 81 and the horizontal line H (x-axis direction) is identified as an angle of the swing plane.

In this embodiment, as the difference in golf swings regarding the swing attention point 49D "angle of swing plane", the angle θ6 of the swing plane of the first reference golf swing information 65 is subtracted from the angle θ6 of the first golf swing information 53A. The larger the difference, the closer to the ball 14 the first golfer 5 of the first golf swing information 53A approaches than the first golfer 5 of the first reference golf swing information 65.

### Difference (Swing Tempo)

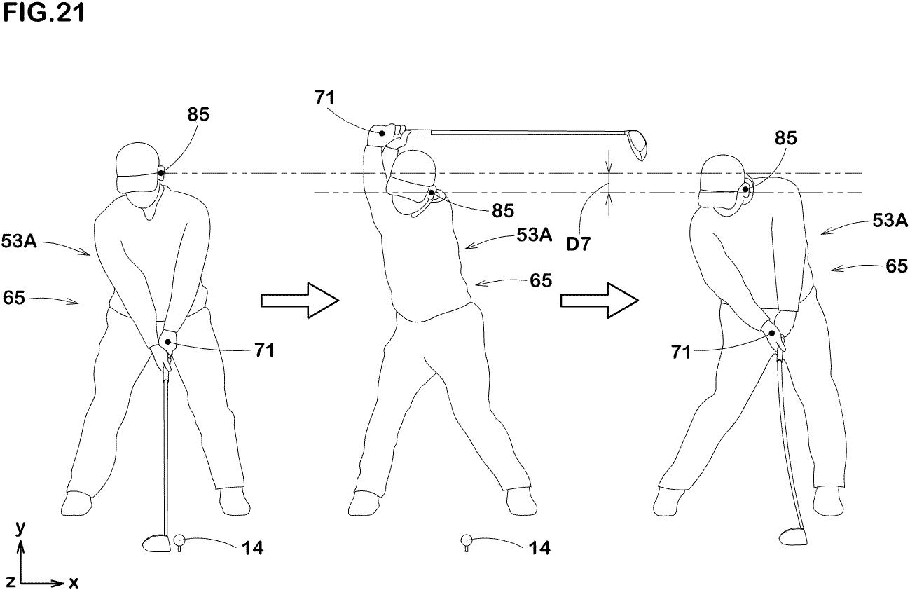

FIG. 21 is a diagram illustrating the difference in golf swings regarding the swing attention points 49D "swing tempo" and "amount of vertical movement of golfer's head during swing". In this embodiment, when the difference in golf swings regarding the swing attention point 49D "swing tempo" is extracted, a difference in the "duration from the start of a swing to impact" between the first reference golf swing information 65 and the first golf swing information 53A is extracted.

The duration from the start of a swing to impact can be acquired as appropriate if the swing tempo can be converted into numerical form. In this embodiment, by taking the position of the center position 71 of the back of the left hand of the golfer at address in the vertical direction (y-axis direction) as zero, the moment when that center position 71 becomes larger than zero (i.e., the y-axis value starts increasing) is identified as a start of the swing. After the swing starts, the moment when the position (y-axis value) of the center position 71 in the vertical direction becomes minimum is identified as a moment of impact (when the head makes an impact on the ball 14). Then, the duration from the start of the swing to the impact is identified as the swing tempo with respect to the first reference golf swing information 65 and the first golf swing information 53A.

In this embodiment, as a difference in golf swings regarding the swing attention point 49D "swing tempo", the tempo (duration) of the swing of the first reference golf swing information 65 is subtracted from the tempo (duration) of the swing of the first golf swing information. The smaller (minus) the difference, the slower the golf swing of the first golfer 5 in the first golf swing information 53A than his or her ideal golf swing in the first reference golf swing information 65.a

### Difference (Amount of Vertical Movement of Golfer's Head During Swing)

Next, when the difference in golf swings is extracted for the swing attention point 49D "amount of vertical movement of golfer's head during swing", a difference is extracted in the "amount of vertical movement of the golfer's head from the start of a swing to impact" between the first reference golf swing information 65 and the first golf swing information 53A.

The amount of vertical movement of the golfer's head from the start of a swing to impact can be acquired as appropriate if the amount of vertical movement of the golfer's head during swing can be converted into numerical form. As shown in FIG. 21, a distance between an uppermost position and a lowermost position in the vertical direction of a left ear 85 of the golfer from the start of a swing to impact is identified as an amount of vertical movement D7 of the golfer's head in this embodiment. The uppermost position and the lowermost position of the golfer's left ear 85 are identified by taking the position of the left ear 85 of the golfer at address in the vertical direction (y-axis direction) as zero. The amount of vertical movement D7 of the golfer's head is identified for each of the first reference golf swing information 65 and the first golf swing information 53A. It should be noted that the start of a swing and the moment of impact are identified by a procedure identical to that of the "swing tempo" described above.

In this embodiment, as the difference in golf swings regarding the swing attention point 49D "amount of vertical movement of the golfer's head during swing", the amount of vertical movement D7 in the first reference golf swing information 65 is subtracted from the amount of vertical movement D7 in the first golf swing information. The larger the difference, the larger the amount of vertical movement D7 of the head of the first golfer 5 in the first golf swing information 53A is compared with the first golfer 5 in the first reference golf swing information 65.

### Provision of Advice Information

Next, at Step S9 of providing the advice information in this embodiment, it is determined whether the difference in golf swings is larger than a predetermined threshold for the swing attention points 49D. In this embodiment, it is determined whether the difference in golf swings is larger than the threshold for the swing attention points 49D "angle of swing plane", "swing tempo", and "amount of vertical movement of golfer's head during swing".

The threshold is set for each swing attention point 49D. In this embodiment, the swing attention point 49D having the difference in golf swings larger than the threshold is determined as the swing attention point 49D to be improved by the first golfer 5.

Next, at Step S9 in this embodiment, the advice information 49A is selected from the advice information table 47 based on the magnitude of the difference in golf swings and the information provision priority 49E (first priority 50) shown in FIG. 5. In this embodiment, when there is only one swing attention point 49D with the difference in golf swings larger than the threshold, the advice information 49A of the record 48 where the one swing attention point 49D is stored is acquired from the advice information table 47. On the other hand, when there are multiple swing attention points having the difference in golf swings larger than the threshold, one swing attention point 49D with the highest first priority 50 (that is, the smallest numerical value) is selected. Then, the advice information 49A of the record 48 where the selected swing attention point 49D is stored is acquired. The acquired advice information 49A is provided to the first golfer 5 (shown in FIG. 1).

In the information providing method of this embodiment, as with the above-described embodiments, it is possible to provide the appropriate advice information 49A in accordance with the needs and the golf swing of the first golfer 5. Further, in this embodiment, the ideal swing determined by the first golfer 5 is retrieved as the first reference golf swing information 65. Thus, the golfer 5 can reproduce his or her ideal golf swing by improving his or her golf swing based on the provided advice information 49A in the information providing method of this embodiment.

### Golfer-Oriented Information Providing Method (Fourth Embodiment)

While the first golf swing information 53A (shown in FIG. 6) and the reference golf swing information 56A (shown in FIG. 7) in the above-described embodiments are acquired as two-dimensional moving images (or still images), they may be acquired as three-dimensional moving images (or still images). As a result, it is possible that the difference in golf swings between the first reference golf swing information 65 and the first golf swing information 53A is extracted more accurately. It should be noted that, a three-dimensional camera (not shown) or the like may be used for taking a three-dimensional moving image (or still image), for example. The three-dimensional camera may be provided in the portable terminal 2 or may be independent of the portable terminal 2.

### Golfer-Oriented Information Providing Method (Fifth Embodiment)

While the reference golf swing information 56A of the above-described embodiments is prepared as image data obtained by taking images of a golf swing by a real golfer (including the first golfer 5), this is not meant to be restrictive. For example, a golf swing of a golfer virtually created by the computer 3 may be used for the reference golf swing information 56A. Therefore, the reference golf swing information 56A under various conditions can be easily created without being limited to the images of the golf swing taken in real life. Thereby, it is possible that appropriate advice information is provided to the golfer in accordance with his or her needs and swings in this embodiment.

While detailed descriptions have been made of particularly preferred embodiments of the present disclosure, the present disclosure can be embodied in various forms without being limited to the illustrated embodiments. For example, in the above-described embodiments, the portable terminal 2 which takes images of the golf swings and the portable terminal which the first golfer operates to acquire the advice information are identical. However, different portable terminals 2 may be used for implementation. Further, while the images of golf swings are taken from the "front" or "rear" in the above-described embodiments, the present disclosure is not limited to this mode. For example, front and rear golf swing information may be acquired by performing image processing (estimation) on a golf swing imaged obliquely (between the front and the rear).

### Statement of Disclosure

The present disclosure includes the following aspects.

### Present Disclosure 1

A golfer-oriented information providing method for providing information to a golfer, including steps of:
inputting pieces of needs information of multiple types regarding a need of a golfer associated with a golf swing to a computer;
inputting, to the computer, for each of the pieces of the needs information of the multiple types, swing attention points for achieving the golf swing satisfying the need and advice information for each of the swing attention points, the advice information being assigned with an information provision priority in regard to each of the pieces of the needs information of the multiple types;
inputting a plurality of pieces of reference golf swing information to the computer, the reference golf swing information being information about a golf swing serving as a target for comparison;
importing first needs information from among the pieces of the needs information of the multiple types into the computer, the first needs information being the needs information requested by a first golfer as a target for providing the information;
inputting first golf swing information to the computer, the first golf swing information being image data of a golf swing of the first golfer;
retrieving first reference golf swing information by the computer based on the first needs information, the first reference golf swing information being one of the pieces of the reference golf swing information most relevant to the first needs information;
extracting, by the computer, a difference in golf swings between the first reference golf swing information and the first golf swing information regarding the swing attention points satisfying the first needs information; and
selecting, by the computer, the advice information based on a magnitude of the difference and the information provision priority and providing the selected advice information to the first golfer.

### Present Disclosure 2

The method according to Present Disclosure 1, wherein

regarding the swing attention points inputted to each of the pieces of the needs information of the multiple types, the information provision priority includes a first priority for selecting the advice information in decreasing order of degrees of importance for achieving the golf swing satisfying the need.

### Present Disclosure 3

The method according to Present Disclosure 1, wherein

regarding the swing attention points inputted to each of the pieces of the needs information of the multiple types, the information provision priority includes a second priority for selecting the advice information in decreasing order of a ratio of the difference.

### Present Disclosure 4

The method according to Present Disclosure 1, wherein

the pieces of the needs information include improvement in a carry of a struck ball.

### Present Disclosure 5

The method according to Present Disclosure 4, wherein

the swing attention points include at least one of a way of holding a grip at address, timing when a wrist cock is released at downswing, and a pause duration at a swing top.

### Present Disclosure 6

The method according to Present Disclosure 1, wherein

the pieces of the needs information include suppression of a slice of a struck ball.

### Present Disclosure 7

The method according to Present Disclosure 6, wherein

the swing attention points include at least one of a way of holding a grip at address, an amount of movement of a left knee at downswing, and a swing path.

### Present Disclosure 8

The method according to Present Disclosure 1, wherein

the pieces of the needs information include improvement in a top strike.

### Present Disclosure 9

The method according to Present Disclosure 8, wherein

the swing attention points include at least one of a position of a golfer's head at address and an amount of opening of a golfer's left underarm at impact.

### Present Disclosure 10

The method according to Present Disclosure 1, wherein

the pieces of the needs information include reproduction of an ideal swing determined by the first golfer.

### Present Disclosure 11

The method according to Present Disclosure 10, wherein

the swing attention points include at least one of an angle of a swing plane, a swing tempo, and an amount of vertical movement of a golfer's head at swing.

### Present Disclosure 12

A tangible computer readable storage medium storing a program for providing information to a golfer, the program causing a computer to function as:
means for inputting pieces of needs information of multiple types regarding a need of the golfer associated with a golf swing;
means for inputting, for each of the pieces of the needs information of the multiple types, a plurality of swing attention points for achieving a golf swing matching the need and advice information for each of the swing attention points, the advice information being assigned with an information provision priority for each of the pieces of the needs information of the multiple types;
means for inputting a plurality of pieces of reference golf swing information, the reference golf swing information being information about a golf swing serving as a target for comparison;
means for importing first needs information from among the pieces of the needs information of the multiple types, the first needs information being the needs information requested by a first golfer as a target for providing the information;
means for inputting first golf swing information, the first golf swing information being image data of a golf swing of the first golfer;
means for retrieving first reference golf swing information from among the pieces of the reference golf swing information based on the first needs information, the first reference golf swing information being one of the pieces of the reference golf swing information most relevant to the first needs information;
means for extracting a difference in golf swings between the first reference golf swing information and the first golf swing information regarding the plurality of the swing attention points associated with the first needs information; and
means for selecting the advice information based on a magnitude of the difference and the information provision priority and providing the selected advice information to the first golfer.

### Present Disclosure 13

A golfer-oriented information providing device including an arithmetic processing device for providing information to a golfer, the arithmetic processing device including:
a needs information input part for inputting pieces of needs information of multiple types regarding a need of a golfer associated with a golf swing;
an advice information input part for inputting, for each of the pieces of needs information of the multiple types, a plurality of swing attention points for achieving a golf swing matching the need and advice information for each of the swing attention points, the advice information being assigned with an information provision priority for each of the pieces of the needs information of the multiple types;
a reference golf swing information input part for inputting a plurality of pieces of reference golf swing information, the reference golf swing information being information about a golf swing serving as a target for comparison;
a first needs information import part for importing first needs information from among the pieces of the needs information of the multiple types, the first needs information being the needs information requested by a first golfer as a target for providing the information;
a first golf swing information input part for inputting first golf swing information, the first golf swing information being image data of a golf swing of the first golfer;
a first reference golf swing information retrieving part for retrieving first reference golf swing information from among the pieces of the reference golf swing information based on the first needs information, the first reference golf swing information being one of the pieces of the reference golf swing information most relevant to the first needs information;
a difference extraction part for extracting a difference in golf swings between the first reference golf swing information and the first golf swing information regarding the swing attention points associated with the first needs information; and
an advice information providing part for selecting the advice information based on a magnitude of the difference and the information provision priority and providing the selected advice information to the first golfer.

### Description of Reference Signs

S1 inputting need information regarding a golf swing
S2 inputting swing attention points and advice information
S3 inputting reference golf swing information
S5 importing first needs information of the first golfer
S6 inputting first golf swing information of the first golfer
S7 retrieving first reference golf swing information
S8 extracting a difference between the first reference golf swing information and the first golf swing information
S9 selecting the advice information based on a magnitude of the difference and information provision priority

1. A golfer-oriented information providing method for providing information to a golfer, comprising steps of:
inputting pieces of needs information of multiple types regarding a need of a golfer associated with a golf swing to a computer;
inputting, to the computer, for each of the pieces of the needs information of the multiple types, swing attention points for achieving the golf swing satisfying the need and advice information for each of the swing attention points, the advice information being assigned with an information provision priority in regard to each of the pieces of the needs information of the multiple types;
inputting a plurality of pieces of reference golf swing information to the computer, the reference golf swing information being information about a golf swing serving as a target for comparison;
importing first needs information from among the pieces of the needs information of the multiple types into the computer, the first needs information being the needs information requested by a first golfer as a target for providing the information;
inputting first golf swing information to the computer, the first golf swing information being image data of a golf swing of the first golfer;
retrieving first reference golf swing information by the computer based on the first needs information, the first reference golf swing information being one of the pieces of the reference golf swing information most relevant to the first needs information;
extracting, by the computer, a difference in golf swings between the first reference golf swing information and the first golf swing information regarding the swing attention points satisfying the first needs information; and
selecting, by the computer, the advice information based on a magnitude of the difference and the information provision priority and providing the selected advice information to the first golfer.

2. The method according to claim 1, wherein
regarding the swing attention points inputted to each of the pieces of the needs information of the multiple types, the information provision priority includes a first priority for selecting the advice information in decreasing order of degrees of importance for achieving the golf swing satisfying the need.

3. The method according to claim 1, wherein
regarding the swing attention points inputted to each of the pieces of the needs information of the multiple types, the information provision priority includes a second priority for selecting the advice information in decreasing order of a ratio of the difference.

4. The method according to claim 1, wherein
the pieces of the needs information include improvement in a carry of a struck ball.

5. The method according to claim 4, wherein
the swing attention points include at least one of a way of holding a grip at address, timing when a wrist cock is released at downswing, and a pause duration at a swing top.

6. The method according to claim 1, wherein
the pieces of the needs information include suppression of a slice of a struck ball.

7. The method according to claim 6, wherein
the swing attention points include at least one of a way of holding a grip at address, an amount of movement of a left knee at downswing, and a swing path.

8. The method according to claim 1, wherein
the pieces of the needs information include improvement in a top strike.

9. The method according to claim 8, wherein
the swing attention points include at least one of a position of a golfer's head at address and an amount of opening of a golfer's left underarm at impact.

10. The method according to claim 1, wherein
the pieces of the needs information include reproduction of an ideal swing determined by the first golfer.

11. The method according to claim 10, wherein
the swing attention points include at least one of an angle of a swing plane, a swing tempo, and an amount of vertical movement of a golfer's head at swing.

12. A tangible computer readable storage medium storing a program for providing information to a golfer, the program causing a computer to function as:
means for inputting pieces of needs information of multiple types regarding a need of the golfer associated with a golf swing;
means for inputting, for each of the pieces of the needs information of the multiple types, a plurality of swing attention points for achieving a golf swing matching the need and advice information for each of the swing attention points, the advice information being assigned with an information provision priority for each of the pieces of the needs information of the multiple types;
means for inputting a plurality of pieces of reference golf swing information, the reference golf swing information being information about a golf swing serving as a target for comparison;
means for importing first needs information from among the pieces of the needs information of the multiple types, the first needs information being the needs information requested by a first golfer as a target for providing the information;
means for inputting first golf swing information, the first golf swing information being image data of a golf swing of the first golfer;
means for retrieving first reference golf swing information from among the pieces of the reference golf swing information based on the first needs information, the first reference golf swing information being one of the pieces of the reference golf swing information most relevant to the first needs information;
means for extracting a difference in golf swings between the first reference golf swing information and the first golf swing information regarding the plurality of the swing attention points associated with the first needs information; and
means for selecting the advice information based on a magnitude of the difference and the information provision priority and providing the selected advice information to the first golfer.

13. A golfer-oriented information providing device including an arithmetic processing device for providing information to a golfer, the arithmetic processing device comprising:
a needs information input part for inputting pieces of needs information of multiple types regarding a need of a golfer associated with a golf swing;
an advice information input part for inputting, for each of the pieces of needs information of the multiple types, a plurality of swing attention points for achieving a golf swing matching the need and advice information for each of the swing attention points, the advice information being assigned with an information provision priority for each of the pieces of the needs information of the multiple types;
a reference golf swing information input part for inputting a plurality of pieces of reference golf swing information, the reference golf swing information being information about a golf swing serving as a target for comparison;
a first needs information import part for importing first needs information from among the pieces of the needs information of the multiple types, the first needs information being the needs information requested by a first golfer as a target for providing the information;
a first golf swing information input part for inputting first golf swing information, the first golf swing information being image data of a golf swing of the first golfer;
a first reference golf swing information retrieving part for retrieving first reference golf swing information from among the pieces of the reference golf swing information based on the first needs information, the first reference golf swing information being one of the pieces of the reference golf swing information most relevant to the first needs information;
a difference extraction part for extracting a difference in golf swings between the first reference golf swing information and the first golf swing information regarding the swing attention points associated with the first needs information; and
an advice information providing part for selecting the advice information based on a magnitude of the difference and the information provision priority and providing the selected advice information to the first golfer.
